(19) United States
(12) Patent Application Publication
(10) Pub. No.: US 2025/0129187 A1
(43) Pub. Date: Apr. 24, 2025

(54) METHODS FOR SYNTHESIS OF DYE-LABELED POLYMERS

(71) Applicant: King Abdullah University of Science and Technology, Thuwal (SA)

(72) Inventors: Antonia Sugar, Thuwal (SA); Maged Fouad Serag, Thuwal (SA); Satoshi Habuchi, Thuwal (SA); Hussein Ali Hoteit, Thuwal (SA); Maram Mansoor Abadi, Thuwal (SA)

(21) Appl. No.: 18/693,068

(22) PCT Filed: Sep. 16, 2022
(86) PCT No.: PCT/IB2022/058786

§ 371 Date: Mar. 18, 2024

Related U.S. Application Data
(60) Provisional application No. 63/244,941, filed on Sep. 16, 2021.

(51) Int. Cl. C08F 8/32

(52) U.S. Cl. CPC C08F 8/32

(57) ABSTRACT

Dye-labeled polymers formed from a polymer and a dye are disclosed. Methods for labeling a polymer with a dye are also disclosed. The polymer can have any weight average molecular weight (Mw), particularly a Mw of >5 megadalton (MDa) or >6 MDa. The polymer contains reactive group(s) that can be activated by an activation agent in a buffer solution. Upon activation, the polymer bundles and forms activated polymer in a solid form. The activated polymer can react with a reactive group of the dye to form the dye-labeled polymer. By soaking the dye-labeled polymer in a solid form in an aqueous solvent, the dye-labeled polymer can regain the viscosifying property that is the same or substantially the same as the polymer prior to labeling with the dye.

### CROSS-REFERENCE TO RELATED APPLICATION

The present application claims priority to U.S. Application No. 63/244,941 filed Sep. 16, 2021, the disclosure of which is incorporated herein by reference in its entirety.

### FIELD OF THE INVENTION

This invention relates to methods for synthesis of dye-labeled polymers.

### BACKGROUND OF THE INVENTION

The polyacrylamide groups of polymers and many of their chemical derivatives (such as partially hydrolyzed polyacrylamides, anionic polyacrylamides, associative polymers, and others) are widely used in a variety of industrial applications. Polyacrylamides based polymers are inexpensive and commercially available. Their various applications in the oil and gas industry include, using polymers for enhanced oil recovery (EOR), conformance control, well stimulation, and rock fracturing in unconventional shale formation. These polymers have other environmental applications in surface and subsurface water management, such as aquifer remediation, polymer treatment and flocculants.

Polyacrylamides are soluble in water and brine. Dissolving small amounts of the polymer in water can increase its viscosity by at least an order of magnitude. The ability to increase water viscosity has many benefits. For instance, polymer injection has been deployed as an effective oil recovery method in numerous oilfields around the world. Polymer flood can provide an incremental oil recovery up to 15% compared to the water injection baseline. Polymer flow in porous rock has been extensively studied. However, many flow mechanisms, such as polymer retention, resistance to flow, and accessibility to the rock pore network, are not well understood. Fluorescently labeled polymers allow tracking (and measuring) the dynamic behavior of these polymer molecules, which provide a means to better understand their flow characteristics in porous formation, to improve polymer deployment in the field.

However, the majority of methods used to label polymers with fluorescent probes are tailored for biopolymers and proteins. Approaches to label synthetic polymers (such as polyacrylamides) are limited, and can be classified in two main categories: co-polymerization methods and post-polymerization tagging methods.

The co-polymerization methods are complex synthesis processes by which the fluorescent-labelled polymer can be synthesized in two different ways: (1) the process takes place in the presence of a standalone fluorescent group, and (2) the fluorescence moiety is incorporated in a monomer prior to polymerization. Methods that fall under the category of co-polymerization are described in U.S. Pat. No. 4,194,877 to Peterson and in a study by Teramoto and co-workers (Teramoto, et al., Journal of Polymer Science Part A-2: Polymer Physics, 5(1):37-45 (1967)), where the polymerization is carried out in the presence of fluorescein sodium. Other approaches on co-polymerization involve a fluorescently labeled acrylamide monomer (U.S. Pat. Nos. 5,043,406, 4,999,456 and. 5,986,030), and acrylic acid co-polymerization with pyrene-labelled monomers (Chu and Thomas, Macromolecules, 17; 2124-2147 (1984); U.S. Pat. No. 6,312,644 to Moriarty, et al.; and Turro and Arora, Polymer, 27(5):783-796 (1986)).

The problem with these copolymerization methods is that the synthesis process is complicated, and requires advanced equipment that renders it impractical and expensive to conduct. Moreover, the methods are hardly scalable, severely affecting their industrial applications.

Post-polymerization tagging methods involve both amide and the carboxyl transformation subgroups. Attempts have been made to conduct polymer labelling by modifying the amide sites of the polymers to crosslink with a fluorescent dye. Prior methods rely on the Hoffman degradation (Inman & Dintzis, Biochemistry, 8(10):4074-4082 (1969); Ricka, et al., Macromolecules, 20(6):1407-1411 (1987)); transamidation (U.S. Pat. No. 5,128,419); adaptation of Holzwarth (Ibid) polysaccharides' labelling procedure to tag polyacrylamide copolymers by coupling the carboxyl group with a fluorescent primary amine through cyanide linkage (U.S. Pat. No. 4,629,566); and labeling of partially hydrolyzed polyacrylamides with a bi-functional moiety of the dansyl fluorescent probe using caproic acid, which is a skin corrosive substance (WO 03/062349). A post-polymerization modification of polyacrylamide with fluorescent groups is disclosed in U.S. Pat. No. 4,813,973 to Winnik and Borg; however, it presents with problems of the fluorescence dye exhibiting carbocation stability values restricted to a specific range.

These post-polymerization tagging methods have intrinsic drawbacks that limit their industrial and commercial applications. For instance, they require sophisticated, time-consuming and labor-intensive chemical synthesis, elevated pressure and temperature conditions, hazardous chemicals, complex, bulky, and costly equipment, among other issues. Some labelling approaches are also accompanied by undesired polymer degradation, which greatly deteriorate the viscosity of the solution, and jeopardize their efficiency. Additionally, these methods can induce changes in polymer dynamics (WO 03/062349 by Warshawsky). This alteration of polymer properties results in quantitative changes in the viscosity, which deeply affects the rheological behavior of the polymer solution. Polymers are used in enhanced oil recovery methods due to their ability to create viscous solutions, thus viscosity is needed to increase oil recovery. Since viscosity is the main contributor for their usage in most applications, it needs to be preserved after the labelling process. The post-polymerization tagging report labelling of polyacrylamides based polymers with molecular weight restricted to 5-6 MegaDalton (MDa) or lower.

There is still a need for methods for labeling a polymer with a dye, such as a fluorescent dye, which allows labeling of higher molecular weight polymers (such as 5 MDa and higher) than previously attained.

It is an object of the present invention to provide methods for labeling a polymer with a dye, such as a fluorescent dye, which allows for labeling and recovery of high molecular weight polymers.

It is also an object of the present invention to provide fluorescently labeled polymers of high molecular weight, such as a weight average molecular weight (Mw) of at least 5 MDa.

It is a further object of the present invention to provide a reaction intermediate (also referred herein as “activated polymer”) formed in a method for labeling a polymer that has a different physical property from the polymer prior to activation.$

### SUMMARY OF THE INVENTION

Dye-labeled polymers formed from a polymer and a dye, and methods of making the same, are disclosed.

The polymer (to be labelled) can have any weight average molecular weight (Mw) as long as the polymer can dissolve in water and form a homogeneous polymer solution. The term “homogenous polymer solution” means that the polymer is uniformly distributed in water. For example, the polymer, after dissolving in water, does not form polymer clumps. In particular, the polymer can have a Mw of ≥5 megadalton (MDa), ≥5 MDa, ≥6 MDa, ≥6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa. In some preferred forms, the polymer has a Mw in a range between 5 MDa and 20 MDa, or between 6 MDa and 20 MDa.

In some forms, the polymer contains a plurality of subunits, where at least one subunit contains a carboxyl group, optionally, more than one carboxyl group, and the dye contains an amino group, optionally more than one amino group. In some forms, a polymer containing carboxyl group(s) is/are activated by an activation agent or a mixture of two or more activation agents, in a buffer solution. To activate the polymer, the polymer (in a solid form) is dissolved in water to form a polymer solution, and then mixed with the activation agent in a buffer solution. The polymer solution and the activation agent(s) is/are each soluble in the buffer solution. In some forms, the concentration of the activation agent or concentration of each activation agent in a mixture of two or more activation agents is at least 4×10⁵ fold of the concentration of the polymer. Such high excess activation agent(s) can trigger transient chain bundling of the polymer to provide an activated polymer in a solid form, such that the activated polymer in the buffer solution is in the form of a suspension. For example, upon activation, the polymer that is soluble in the buffer solution forms an activated polymer that is suspended in the buffer solution. This allows efficient purification of the activated polymer from the mixture of unreacted activation agent(s) and the activated polymer using a conventional purification method, such as centrifugation.

The activated polymer can react with a reactive group of the dye to form a dye-labeled polymer. Typically, the dye-labeled polymer is in a solid form during purification and/or washing. The dye-labeled polymer can regain its viscosifying property after being soaked in an aqueous solvent, such as water. In some forms, the dye-labeled polymer after being soaked in the aqueous solvent has the same or substantially the same viscosifying property as the polymer prior to labeling with the dye.

### BRIEF DESCRIPTION OF THE DRAWINGS

FIG. 1 is a schematic illustrating the general principle of a carbodiimide crosslinking reaction.

FIGS. 2A-2C are graphs showing the FTIR spectra of the HPAM polymer (FIG. 2A), the dye molecule iFluor™ 647 amine (FIG. 2B), and the dye-labeled HPAM polymer (FIG. 2C).

FIGS. 3A-3C are graphs showing the UV-vis spectra of the HPAM polymer (FIG. 3A), the dye molecule iFluor™ 647 amine (FIG. 3B), and the dye-labeled HPAM polymer (FIG. 3C).

FIGS. 4A-4B are images showing the shape of the HPAM polymer molecule in its original state (FIG. 4A) and the HPAM/EDC/NHS complex (i.e. the activated HPAM polymer) undergoing transient chain bundling (FIG. 4B) captured by Atomic Force Microscopy (AFM).

### DETAILED DESCRIPTION OF THE INVENTION

### I. Definitions

As used herein, the term “backbone of polymer” refers to the longest series of covalently bonded atoms that together create the continuous chain of the polymer molecule.

As used herein, “Biopolymers” are natural polymers produced by the cells of living organisms.

As used herein, the term “amino group” includes the group NH₂ (primary amino), alkylamino (secondary amino), and dialkylamino (tertiary amino), where the two alkyl groups in dialkylamino may be the same or different, i.e. alkylalkylamino. Illustratively, amino includes methylamino, ethylamino, dimethylamino, methylethylamino, and the like. In addition, it is to be understood that when amino modifies or is modified by another term, such as aminoalkyl, or acylamino, the above variations of the term amino continue to apply. Illustratively, aminoalkyl includes H²N-alkyl, methylaminoalkyl, ethylaminoalkyl, dimethylaminoalkyl, methylethylaminoalkyl, and the like. Illustratively, acylamino includes acylmethylamino, acylethylamino, and the like.

As used herein, the term “alkyl” refers to univalent groups derived from alkanes by removal of a hydrogen atom from any carbon atom.

Alkanes represent saturated hydrocarbons, including those that are linear, branched, or cyclic (either monocyclic or polycyclic). An alkyl can be a linear C₁-C₃₀ alkyl, a branched C₄-C₃₀ alkyl, a cyclic C₃-C₃₀ alkyl, a linear C₁-C₃₀ alkyl or a branched C₄-C₃₀ alkyl, a linear C₁-C₃₀ alkyl or a cyclic C₃-C₃₀ alkyl, a branched C₄-C₃₀ alkyl or a cyclic C₃-C₃₀ alkyl. Optionally, alkyl groups have up to 20 carbon atoms. An alkyl can be a linear C₁-C₂₀ alkyl, a branched C₄-C₂₀ alkyl, a cyclic C₃-C₂₀ alkyl, a linear C₁-C₂₀ alkyl or a branched C₄-C₂₀ alkyl, a branched C₄-C₂₀ alkyl or a cyclic C₃-C₂₀ alkyl, a linear C₁-C₂₀ alkyl or a cyclic C₃-C₂₀ alkyl. Optionally, alkyl groups have up to 10 carbon atoms. An alkyl can be a linear C₁-C₁₀ alkyl, a branched C₄-C₁₀ alkyl, a cyclic C₃-C₁₀ alkyl, a linear C₁-C₁₀ alkyl or a branched C₄-C₁₀ alkyl, a branched C₄-C₁₀ alkyl or a cyclic C₃-C₁₀ alkyl, a linear C₁-C₁₀ alkyl or a cyclic C₃-C₁₀ alkyl. Optionally, alkyl groups have up to 6 carbon atoms. An alkyl can be a linear C₁-C₆ alkyl, a branched C₄-C₆ alkyl, a cyclic C₃-C₆ alkyl, a linear C₁-C₆ alkyl or a branched C₄-C₆ alkyl, a branched C₄-C₆ alkyl or a cyclic C₃-C₆ alkyl, or a linear C₁-C₆ alkyl or a cyclic C₃-C₆ alkyl. Optionally, alkyl groups have up to four carbons. An alkyl can be a linear C₁-C₄ alkyl, cyclic C₃-C₄ alkyl, a linear C₁-C₄ alkyl or a cyclic C₃-C₄ alkyl. Preferably, the alkyl group is an unsubstituted alkyl group. Preferably, the alkyl group is a linear C₁-C₅, C₁-C₄, C₁-C₃, C₁-C₂ alkyl group, such as, a methyl group.

As used herein, the term “alkenyl” refers to univalent groups derived from alkenes by removal of a hydrogen atom from any carbon atom. Alkenes are unsaturated hydrocarbons that contain at least one carbon-carbon double bond. Alkenyl group can be linear, branched, or cyclic. Thus, an alkenyl can be a linear C₂-C₃₀ alkenyl, a branched C₄-C₃₀ alkenyl, a cyclic C₃-C₃₀ alkenyl, a linear C₂-C₃₀ alkenyl or a branched C₄-C₃₀ alkenyl, a linear C₂-C₃₀ alkenyl or a cyclic C₃-C₃₀ alkenyl, a branched C₄-C₃₀ alkenyl or a cyclic C₃-C₃₀ alkenyl. Optionally, alkenyl groups have up to 20 carbon atoms. An alkenyl can be a linear C₂-C₂₀ alkenyl, a branched C₄-C₂₀ alkenyl, a cyclic C₃-C₂₀ alkenyl, a linear C₂-C₂₀ alkenyl or a branched C₄-C₂₀ alkenyl, a linear C₂-C₂₀ alkenyl or a cyclic C₃-C₂₀ alkenyl, a branched C₄-C₂₀ alkenyl or a cyclic C₃-C₂₀ alkenyl. Optionally, alkenyl groups have two to 10 carbon atoms. An alkenyl can be a linear C₂-C₁₀ alkenyl, a branched C₄-C₁₀ alkenyl, a cyclic C₃-C₁₀ alkenyl, a linear C₂-C₁₀ alkenyl or a branched C₄-C₁₀ alkenyl, a linear C₂-C₁₀ alkenyl or a cyclic C₃-C₁₀ alkenyl, a branched C₄-C₁₀ alkenyl or a cyclic C₃-C₁₀ alkenyl. Optionally, alkenyl groups have two to 6 carbon atoms. An alkenyl can be a linear C₂-C₆ alkenyl, a branched C₄-C₆ alkenyl, a cyclic C₃-C₆ alkenyl, a linear C₂-C₆ alkenyl or a branched C₄-C₆ alkenyl, a linear C₂-C₆ alkenyl or a cyclic C₃-C₆ alkenyl, a branched C₄-C₆ alkenyl or a cyclic C₃-C₆ alkenyl. Optionally, alkenyl groups have two to four carbons. An alkenyl can be a linear C₂-C₄ alkenyl, a cyclic C₃-C₄ alkenyl, a linear C₂-C₄ alkenyl or a cyclic C₃-C₄ alkenyl.

As used herein, the term “aryl” refers to univalent groups derived from arenes by removal of a hydrogen atom from a ring atom. Arenes are monocyclic and polycyclic aromatic hydrocarbons. In polycyclic aryl groups, the rings can be attached together in a pendant manner or can be fused. Aryl group can have six to 50 carbon atoms. An aryl can be a branched C₆-C₅₀ aryl, a monocyclic C₆-C₅₀ aryl, a polycyclic C₆-C₅₀ aryl, a branched polycyclic C₆-C₅₀ aryl, a fused poly cyclic C₆-C₅₀ aryl, or a branched fused polycyclic C₆-C₅₀ aryl. Optionally, aryl groups have six to 30 carbon atoms, i.e., C₆-C₃₀ aryl. A C₆-C₃₀ aryl can be a branched C₆-C₃₀ aryl, a monocyclic C₆-C₃₀ aryl, a polycyclic C₆-C₃₀ aryl, a branched polycyclic C₆-C₃₀ aryl, a fused polycyclic C₆-C₃₀ aryl, or a branched fused polycyclic C₆-C₃₀ aryl. Optionally, aryl groups have six to 20 carbon atoms, i.e., C₆-C₂₀ aryl. A C₆-C₂₀ aryl can be a branched C₆-C₂₀ aryl, a monocyclic C₆-C₂₀ aryl, a polycyclic C₆-C₂₀ aryl, a branched polycyclic C₆-C₂₀ aryl, a fused polycyclic C₆-C₂₀ aryl, or a branched fused polycyclic C₆-C₂₀ aryl. Optionally, aryl groups have six to twelve carbon atoms, i.e., C₆-C₁₂ aryl. A C₆-C₁₂ aryl can be a branched C₆-C₁₂ aryl, a monocyclic C₆-C₁₂ aryl, a polycyclic C₆-C₁₂ aryl, a branched polycyclic C₆-C₁₂ aryl, a fused polycyclic C₆-C₁₂ aryl, or a branched fused polycyclic C₆-C₁₂ aryl. Optionally, C₆-C₁₂ aryl groups have six to eleven carbon atoms, i.e., C₆-C₁₁ aryl. A C₆-C₁₁ aryl can be a branched C₆-C₁₁ aryl, a monocyclic C₆-C₁₁ aryl, a polycyclic C₆-C₁₁ aryl, a branched polycyclic C₆-C₁₁ aryl, a fused polycyclic C₆-C₁₁ aryl, or a branched fused polycyclic C₆-C₁₁ aryl. Optionally, C₆-C₁₂ aryl groups have six to nine carbon atoms, i.e., C₆-C₉ aryl. A C₆-C₉ aryl can be a branched C₆-C₉ aryl, a monocyclic C₆-C₉ aryl, a polycyclic C₆-C₉ aryl, a branched polycyclic C₆-C₉ aryl, a fused polycyclic C₆-C₉ aryl, or a branched fused polycyclic C₆-C₉ aryl. Optionally, C₆-C₁₂ aryl groups have six carbon atoms, i.e., C₆ aryl. A C₆ aryl can be a branched C₆ aryl or a monocyclic C₆ aryl.

As used herein, the term “substituted,” means that the chemical group or moiety contains one or more substituents replacing the hydrogen atoms in the chemical group or moiety. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc. The substituents include, but are not limited to:
a halogen atom, an alkyl group, a cycloalkyl group, a heteroalkyl group, a cycloheteroalkyl group, an alkenyl group, a heteroalkenyl group, an alkynyl group, a heteroalkynyl group, an aryl group, a heteroaryl group, a polyaryl group, a polyheteroaryl group, —OH, —SH, —NH₂, —N₃, —OCN, —NCO, —ONO₂, —CN, —NC, —ONO, —CONH₂, —NO, —NO₂, —ONH₂, —SCN, —SNCS, —CF₃, —CH₂CF₃, —CH₂Cl, —CHCl₂, —CH₂NH₂, —NHCOH, —CHO, —COCl, —COF, —COBr, —COOH, —SO₃H, —CH₂SO₂CH₃, —PO₃H₂, —OPO₃H₂, —P(═O)(OR^{T1′})(OR^{T2′}), —OP(═O)(OR^{T1′})(OR^{T2′}), —BR^{T1′}(OR^{T2′}), —B(OR^{T1′})(OR^{T2′}), or TG′W in which -T′ is —O—, —S—, —NR^{T2′}—, —C(O)—, —S(═O)—, —SO₂—, —C(═O)O—, —C(═O)NR^{T2′}—, —OC(═O)—, —NR^{T2′}C(═O)—, —OC(═O)O—, —OC(═O)NR^{T2′}—, —NR^{T2′}C(═O)O—, —NR^{T2′}C(═O)NR^{T3′}—, —C(═S)—, —C(═S)S—, —SC(═S)—, —SC(═S)S—, —C(═NR^{T2′})—, —C(═NR^{T2′})O—, —C(═NR^{T2′})NR^{T3′}—, —OC(═NR^{T2′})—, —NR^{T2′}C(═NR^{T3′})—, —NR^{T2′}SO₂—, —C(═NR^{T2′})NR^{T3′}—, —OC(═NR^{T2′})—, —NR^{T2′}C(═NR^{T3′})—, —NR^{T2′}SO₂—, —NR^{T2′}SO₂NR^{T3′}—, —NR^{T2′}C(═S)—, —SC(═S)NR^{T2′}—, —NR^{T2′}C(═S)S—, —NR^{T2′}C(═S)NR^{T3′}—, —SC(═NR^{T2′})—, —C(═S)NR^{T2′}—, —OC(═S)NR^{T2′}—, —NR^{T2′}C(═S)O—, —SC(═O)NR^{T2′}—, —NR^{T2′}C(═O)S—, —C(═O)S—, —SC(═O)—, —SC(═O)S—, —C(═S)O—, —OC(═S)—, —OC(═S)O—, —SO₂NR^{T2′}—, —BR^{T2′}—, or —PR^{T2′}—; where each occurrence of R^{T1′}, R^{T2′}, and R^{T3′} is, independently, a hydrogen atom, a halogen atom, an alkyl group, a heteroalkyl group, an alkenyl group, a heteroalkenyl group, an alkynyl group, a heteroalkynyl group, an aryl group, or a heteroaryl group.

In some instances, “substituted” also refers to one or more substitutions of one or more of the carbon atoms in a carbon chain (e.g., alkyl, alkenyl, and aryl groups) by a heteroatom, such as, but not limited to, nitrogen, oxygen, and sulfur.

Use of the term “about” is intended to describe values either above or below the stated value in a range of approx. +/−10%; in other forms the values may range in value either above or below the stated value in a range of approx. +/−5%. The preceding ranges are intended to be made clear by context, and no further limitation is implied.

Numerical ranges disclosed in the present application of any type, disclose individually each possible number that such a range could reasonably encompass, as well as any sub-ranges and combinations of sub-ranges encompassed therein.

### II. Dye-Labeled Polymers

Disclosed herein are dye-labeled polymers, particularly dye-labeled polymers where the polymer, prior to labeling, has a high weight average molecular weight (Mw), such as a Mw of ≥5 megadalton (MDa), ≥5 MDa, ≥6 MDa, ≥6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa. In some preferred forms, the polymer has a Mw in a range between 5 MDa and 20 MDa, between 6 MDa and 20 MDa, or between about 7 and about 20 MDa, for example, about 8, 9, 10, 11, 12, 13, 14, 15, 16, 17, 18, 19 MDa. The dye-labeled polymers are synthesized according to the methods described below.

The dye-labeled polymers are typically formed by conjugation between a reactive group of a polymer and a reactive group of a dye, such as a fluorescent dye. The conjugation between the reactive groups of the polymer and the dye covalently links the dye to the polymer structure, such as the backbone of the polymer. For example, the dye-labeled polymers are formed from conjugation between a carboxyl group, optionally more than one carboxyl group, of a polymer and an amino group, optionally more than one amino group, of a dye, such that the dye(s) are conjugated to the polymer via an amide bond.

Exemplary polymers that can be labeled with a dye include, but are not limited to polyacrylamide, polycarboxylate ethers, exemplary structures shown below.

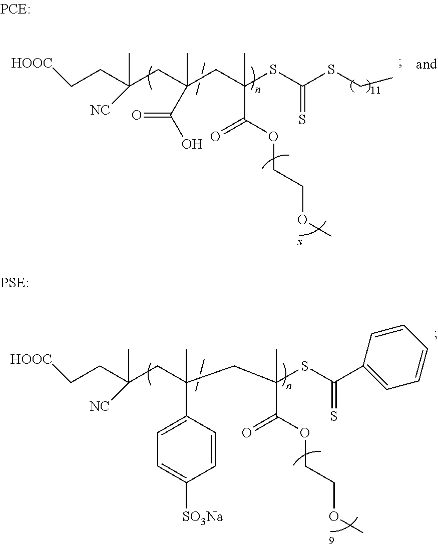

polyamino acids (e.g. polyaspartic acids, polyglutamic acids, and derivatives thereof), and polymaleic acids. Additional exemplary polymers that can be labeled with a dye are also described in Ezzat, et al., Journal of Colloid and Interface Science, 553:788-797 (2019); polymer properties database; Sienz-Galindo, et al., Intechopen, DOI: 10.5772/intechopen.74654; https://www.sigmaaldrich.com/life-science/biochemicals/biochemical-products.html?TablePage=9616613; and U.S. Pat. No. 4,818,795 to Denzinger, et al.

The dye-labeled polymers can have any weight average molecular weight (Mw) as long as the polymer prior to labeling can dissolve in water and form a homogeneous polymer solution. In some preferred forms, the dye-labeled polymer has a Mw of ≥5 megadalton (MDa), ≥5 MDa, ≥6 MDa, ≥6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa.

Typically, the dye-labeled polymers have the same or substantially the same physical properties, such as the molar volume, density, degree of polymerization, and viscosifying property, as the polymer prior to labeling with the dye. In particular, the dye-labeled polymers have the same or substantially the same viscosifying property as the polymer prior to labeling with the dye. For example, the viscosity of a solution prepared by dissolving a dye-labeled polymer in an aqueous solvent, such as water or a buffer solution, is the same or substantially the same as a solution prepared by dissolving the same amount (in moles) of the polymer prior to labeling with the dye in the same aqueous solvent, as measured for example, using a rheometer.

In some forms, the dye-labeled polymer contains at least one subunit having the structure of formula 1 as shown in the brackets:

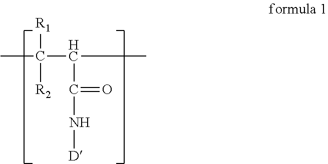

where R₁ and R₂ are independently a hydrogen, a substituted or non-substituted alkyl group, a substituted or non-substituted alkenyl group, or a substituted or non-substituted aryl group, and where NH-D′ is the dye which is linked to the polymer backbone via an amide bond.

In some forms, the substituent(s) in a substituted alkyl group, a substituted alkenyl group, a substituted aryl group, or a substituted alkyl-aryl group are independently a halogen atom, a sulfonic acid, an azide group, a cyanate group, an isocyanate group, a nitrate group, a nitrile group, an isonitrile group, a nitrosooxy group, a nitroso group, a nitro group, an aldehyde group, an alkoxy group, an acyl halide group, a carboxylic acid group, a carboxylate group, an alkyl group, a heteroalkyl group, an alkenyl group, a heteroalkenyl group, an alkynyl group, a heteroalkynyl group, an aryl group, a heteroaryl group, polyaryl group, a heteropolyaryl group, a alkylaryl group, an amino group, an ester group, a hydroxyl group, a thiol group, a sulfonyl group, an amide group, an azo group, an acyl group, a carbonyl group, a carbonate ester group, an ether group, an aminooxy group, or a hydroxyamino group.

In some forms, R₁ and R₂ are independently a hydrogen, a substituted or non-substituted C₁-C₂₀ alkyl group, a substituted or non-substituted C₁-C₁₅ alkyl group, a substituted or non-substituted C₁-C₁₂ alkyl group, a substituted or non-substituted C₁-C₁₀ alkyl group, a substituted or non-substituted C₁-C₆ alkyl group, a substituted or non-substituted C₁-C₄ alkyl group, a substituted or non-substituted C₁-C₃ alkyl group, an ethyl group, or a methyl group. In some forms, at least one of R₁ and R₂ is a hydrogen. In some forms, both R₁ and R₂ are hydrogen.

In some forms, the dye-labeled polymer is a dye-labeled polyacrylamide or a dye-labeled polyacrylamide copolymer. For example, the dye-labeled polymer is a dye-labeled polyacrylamide having the structure of formula 2:

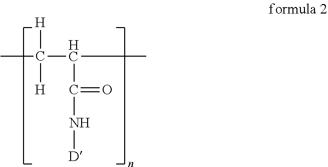

where NH-D′ is the dye which is linked to the polymer backbone via an amide bond and where n is a positive integer of at least 1×10³, at least 1×10⁴, at least 5×10⁴, at least 6×10⁴, at least 7×10⁴, at least 8×10⁴, at least 1×10⁵, up to 1×10⁵, up to 2×10⁵, or up to 3×10⁵.

In some forms, the dye-labeled polymer is a dye-labeled polyacrylamide copolymer that contains at least one polyacrylamide segment having the structure of formula 3:

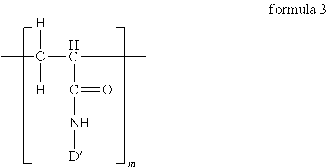

where NH-D′ is the dye which is linked to the polymer backbone via an amide bond and where m is a positive integer at least 1, at least 10, at least 20, at least 50, at least 100, at least 200, at least 500, at least 1×10³, at least 2×10³, at least 5×10³, at least 1×10⁴, up to 1×10⁵, up to 2×10⁵, or up to 3×10⁵.

In some forms, a percentage of the active groups of the polymer are conjugated with the active group of the dye. For example, at least 0.15 mol %, at least 0.2 mol %, at least 0.5 mol %, at least 1 mol %, at least 2 mol %, at least 5 mol %, at least 10 mol %, at least 15 mol %, at least 20 mol %, at least 25 mol %, up to 50 mol %, between 0.15 mol % and 50 mol %, between 0.2 mol % and 50 mol %, between 0.5 mol % and 50 mol %, between 1 mol % and 50 mol %, between 2 mol % and 50 mol %, or between 5 mol % and 50 mol % of the active groups of the polymer are conjugated with the active group of the dye. In some forms, a percentage of the carboxyl groups are conjugated with the amino group of the dye, forming a dye-labeled polymer having or containing a segment having the structure of formula 4:

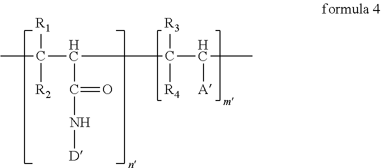

where R₁-R₄ are independently a hydrogen, a substituted or non-substituted alkyl group, a substituted or non-substituted alkenyl group, or a substituted or non-substituted aryl group, where the substituents are as defined above, where NH-D′ is the dye which is linked to the polymer backbone via an amide bond, where A′ is a halogen, an amino group, a carboxyl group, a carboxamide group, or a hydroxyl group, and where n′ and m′ are independently a positive integer at least 1, at least 10, at least 20, at least 50, at least 100, at least 200, at least 500, at least 1×10³, at least 2×10³, at least 5×10³, at least 1×10⁴, up to 1×10⁵, up to 2×10⁵, or up to 3×10⁵. In some forms, R₁-R₄ are independently a hydrogen, a substituted or non-substituted C₁-C₂₀ alkyl group, a substituted or non-substituted C₁-C₁₅ alkyl group, a substituted or non-substituted C₁-C₁₂ alkyl group, a substituted or non-substituted C₁-C₁₀ alkyl group, a substituted or non-substituted C₁-C₆ alkyl group, a substituted or non-substituted C₁-C₄ alkyl group, a substituted or non-substituted C₁-C₃ alkyl group, an ethyl group, or a methyl group.

In some forms, the dye-labeled polymer is a dye-labeled polyacrylamide having the structure of formula 5:

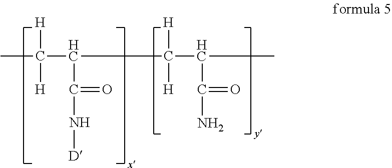

where NH-D′ is the dye which is linked to the polymer backbone via an amide bond and where x′ and y′ are independently a positive integer at least 1, at least 10, at least 20, at least 50, at least 100, at least 200, at least 500, at least 1×10³, at least 2×10³, at least 5×10³, at least 1×10⁴, up to 1×10⁵, up to 2×10⁵, or up to 3×10⁵.

In some forms, the dye-labeled polymer is a dye-labeled partially hydrolyzed polyacrylamide having the structure of formula 6 or formula 7:

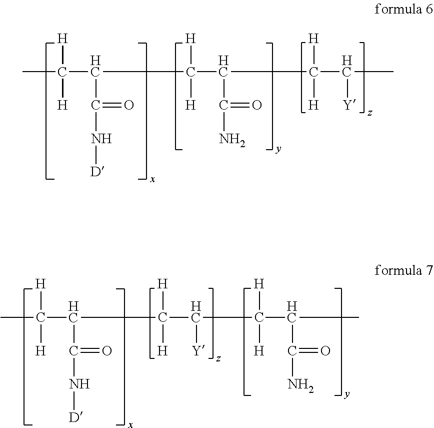

where NH-D′ is the dye which is linked to the polymer backbone via an amide bond, where Y′ is a carboxyl group or a carboxylate group, and where x, y, and z are independently a positive integer at least 1, at least 10, at least 20, at least 50, at least 100, at least 200, at least 500, at least 1×10³, at least 2×10³, at least 5×10³, at least 1×10⁴, up to 1×10⁵, up to 2×10⁵, or up to 3×10⁵.

Fluorophores that can be used to label the polymer include, but not limited to, methoxycoumarin, dansyl, pyrene, ALEXA FLUOR® (fluorescent dye) 350 (blue-fluorescent dye with moderate photostability and excitation that matches the 350 nm laser line), AMCA, marina blue dye, dapoxyl dye, dialkylaminocoumarin, bimane, hydroxycoumarin, cascade blue dye, pacific orange dye, Alexa fluor 405, cascade yellow dye, pacific blue dye, PyMPO, ALEXA FLUOR® 430 (bright green fluorescent dye), NBD-TMA ([2-(4-nitro-2,1,3-benzoxadiazol-7-yl)aminoethyl]trimethylammonium), QSY 35, fluorescein, ALEXA FLUOR® 488, oregon green 488, BODIPY® (fluorescent dye) 493/503, rhodamine green dye, BODIPY FL, 2′, 7′-dichloro-fluorescein, oregon green 514, Alexa Fluor 514, 4′,5′-Dichloro-2′,7′-dimethoxy-fluorescein, eosin, rhodamine 6G, BODIPY R6G, ALEXA FLUOR® 532, BODIPY 530/550, BODIPY TMR, ALEXA FLUOR® 555, tetramethyl-rhodamine, ALEXA FLUOR® 546, BODIPY 558/568, QSY 7, QSY 9, BODIPY 564/571, lissamine rhodamine B, rhodamine red dye, BODIPY 576/589, ALEXA FLUOR® 568, X-rhodamine, BODIPY 581/591, BODIPY TR, ALEXA FLUOR® 594, texas red dye, naphthofluorescein, Alexa Fluor 610, BODIPY 630/650, malachite green, ALEXA FLUOR® 633, ALEXA FLUOR®635 (near infrared, far red fluorescent dye), BODIPY 650/665, ALEXA FLUOR® 647, QSY 21, ALEXA FLUOR® 660, ALEXA FLUOR® 680, ALEXA FLUOR® 700, ALEXA FLUOR® 750, and ALEXA FLUOR®790. The —NH-D′ in any of formula 1-7 is contributed by the amine derivative of the dye, for example, a flurophore.

### III. Methods of Making

Methods for labeling a polymer with a dye/making the dye-labelled polymers described in section II, are disclosed. The labeling methods disclosed herein allow labeling of polymers without any size restrictions, as long as the polymers can dissolve in water to form a homogenous polymer solution. In particular, the labeling methods allow labeling of polymers having a high Mw, such as polymers having a Mw of ≥5 megadalton (MDa), ≥5 MDa, ≥6 MDa, ≥6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa. In some preferred forms, the polymer has a Mw in a range between 5 MDa and 20 MDa, or between 6 MDa and 20 MDa.

While not being bound by theory, the disclosed methods can trigger transient chain bundling of the polymer that changes physical properties (e.g. the viscosifying property) of the polymers, and thereby allow efficient purification of the activated polymers and the dye-labeled polymers to remove excess reagents (i.e. unreacted activation agents or unreacted dye). The viscosifying property of the dye-labeled polymer can be regained by drying and soaking the dye-labeled polymer in an aqueous solvent. For example, the viscosity of a solution prepared by dissolving a dye-labeled polymer in an aqueous solvent, such as water or a buffer solution, is the same or substantially the same as a solution prepared by dissolving the same amount in moles of the polymer prior to labeling with the dye in the same aqueous solvent. The viscosity is considered substantially the same, if it does not deviate by more than 5% of the viscosity, prior to labeling. The viscosity of the polymer solution may be in a range from 1 cP to 200 cP measured using a rheometer under ambient conditions, i.e. at room temperature (i.e. 20-22° C.) and 1 atm.

Generally, the method includes: (i) mixing the polymer with an activation agent, optionally a mixture of two or more activation agents, in a first buffer solution, where upon activation, the polymer bundles and forms an activated polymer in the first buffer solution, and (ii) mixing the activated polymer with the dye in a second buffer solution to form a dye-labeled polymer in the second buffer solution. Typically, the polymer in step (i) is in the form of a solution formed from dissolving the polymer in a solid form, in water (also referred to herein as “polymer solution”). In some preferred forms, the activated polymer formed following step (i) is suspended in the first buffer solution. Alternatively or additionally, the dye-labeled polymer formed following step (ii) is suspended in the second buffer solution.

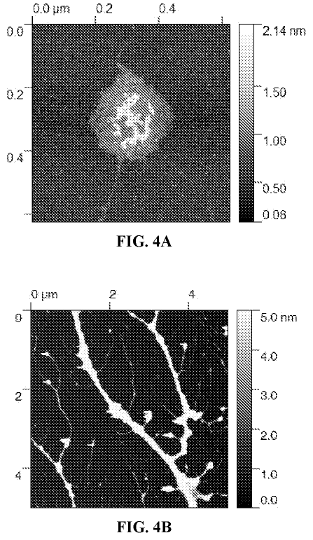

The term “polymer bundles,” “polymer chain bundling,” or “chain bundling of polymer(s)” means the assembly of the chains of multiple polymer molecules (also referred herein as “polymer chains”) that forms an organized structure. For example, the chains of multiple polymer molecules assemble and form an elongated structure, see, e.g. FIG. 4B. In the activation step, i.e. step (i), while not being bound by theory, it is believed that the activation agent or the mixture of activation agents triggers transient chain bundling of the polymer, such that the polymer chains assemble and thereby change the viscosifying property of the polymer. For example, the activation agent or the mixture of activation agents triggers transient chain bundling of the polymer (which is soluble in the first buffer solution), such that the polymer chains assemble and form activated polymer that is suspended in the first buffer solution. The term “transient chain bundling” means that the chain bundling is not permanent, for example, the chain bundling of the polymer may be reversed and the polymer may regain its initial chain state.

The activated polymers formed in step (i) are reactive intermediates that can spontaneously react with the reactive groups of the dye in step (ii), such that the dye is covalently linked to the polymer structure, such as the backbone of the polymer, forming the dye-labeled polymer. For example, the polymer to be labeled contains a carboxyl group, optionally more than one carboxyl group, which can be activated by the activation agent(s) in step (i) followed by conjugation with an amino group, optionally more than one amino group, of the dye in step (ii), such that the dye is conjugated to the polymer structure, such as the backbone of the polymer, via an amide bond.

A. Mixing Polymer(s) with Activation Agent(s) to Form Activated Polymer(s)

Generally, a polymer or a mixture of two or more polymers are mixed with an activation agent or a mixture of two or more activation agents in a buffer solution to form activated polymer(s). Typically, the polymer(s) are dissolved (i.e. soluble) in water to form a polymer solution. The polymer solution and the activation agent(s) may be added to the buffer solution simultaneously, substantially simultaneously, or sequentially. In some forms, the polymer solution and the activation agent(s) are added into the buffer solution sequentially. For example, the polymer solution is added into the buffer solution first to form a mixed buffer solution and the activation agent(s) are then added into the mixed buffer solution. In some preferred forms, the polymer solution and the activation agent(s) in the form of a solution and each of the polymer solution and the activation agent solution is added to the buffer solution dropwise.

Typically, the polymer solution is added to the buffer solution to form a mixed buffer solution having a viscosity that is different from the viscosity of the buffer solution. For example, the viscosity of the mixed buffer solution is higher than the buffer solution without the polymer(s) as measured using a rheometer under ambient conditions. Typically, the activation agent(s) can also dissolve in the buffer solution.

The polymer activation reaction is typically performed at room temperature, i.e. 20-22° C. The period of time sufficient to activate the polymer(s) into activated polymer(s) can be up to up to 1 hour, up to 30 minutes, at least 5 minutes, at least 10 minutes, in a range from 5 minutes to 1 hour, from 5 minutes to 30 minutes. Preferably, the activation is carried out for about 5-40 mins, more preferably, about 10-20 mins. Optionally, the activation reaction is under stirring during the reaction period, such as under magnetic stirring. For example, the polymer activation reaction is performed at room temperature for a period of time up to 1 hour, as disclosed herein optionally under stirring.

In some preferred forms, following the activation of the polymer(s) by the activation agent(s), the activation agent(s) trigger transient chain bundling of the polymer(s) (i.e. the chains of the polymer molecules bundle together), forming activated polymers in the form of solids that are suspended in the buffer solution. The formation of a suspension upon polymer activation results in a transient loss of the viscosity of the mixed buffer solution. The term “transient loss” means that the loss of the viscosity of the solution is not permanent, i.e. the viscosity of the solution may be recovered. In particular, the transient chain bundling of the polymer(s) allows labeling of polymers of high Mw, such as polymers having a Mw more than 5 MDa, optionally more than 6 MDa, for example, about for about 7, 8, 9, 10, 11, 12, 13, 14, 15, 16, 17, 18, 19 MDa, and up to 20 MDa.

Generally, labeling of polymers of high Mw is challenging due to the lack of purification methods that can efficiently remove excess activation agents (i.e. unreacted activation agents) from the mixture of activated polymers (which are characterized by high viscosity (i.e. a viscosity of at least 1 centiPoise (as measured using a rheometer under ambient conditions) and sticky nature to almost all purifying membrane filters)) and excess activation agents. For example, conventional purification methods such as filtration and dialysis used in WO 03/062349 and acetone precipitation disclosed in U.S. Pat. No. 4,629,566 fail to remove the excess activation agents. Such inefficient purification of activated polymers can lead to failure in the subsequent conjugation reactions (i.e. conjugation of the activated polymer with a dye). The transient chain bundling of polymers described in the methods disclosed herein changes the physical property of the polymers by forming activated polymers in the form of solids, thereby allows efficient purification of the activated polymers by removing excess activation agents from the mixture of activated polymers and excess activation agents using a conventional purification method, such as centrifugation. For example, at least 90 mol %, at least 92 mol %, at least 95 mol %, up to 99.5 mol %, up to 99 mol %, between 90 mol % and 99.5 mol %, between 90 mol % and 99 mol %, or between 95 mol % and 99 mol % of the excess activation agents were removed from the mixture of activated polymers and excess activation agents. For example, upon centrifugation, the activated polymers in solid form can precipitate out of the buffer solution while the excess activation agents remain dissolved in the buffer solution (i.e. supernatant), allowing removal of the excess activation agents by decanting the supernatant.

### 1. Polymers

The polymer(s) are dissolved in water to form a polymer solution. The polymer solution is soluble in the buffer solution to form a mixed buffer solution having a viscosity that is different from the viscosity of the buffer solution. For example, the viscosity of the mixed buffer solution is higher than the buffer solution without the polymer(s). Typically, polymers that can be labeled using the method disclosed herein contain a reactive group that can be activated by the activation agent(s) to form activated polymer(s).

Exemplary polymers that can be labeled with a dye include, but are not limited to polyacrylamide, polycarboxylate ethers (e.g. PCE and PSE), polyamino acids (e.g. polyaspartic acids, polyglutamic acids, and their derivatives thereof), and polymaleic acids. Additional exemplary polymers that can be labeled with a dye are also described in Ezzat, et al., Journal of Colloid and Interface Science, 553:788-797 (2019); polymer properties database; Sienz-Galindo, et al., Intechopen, DOI: 10.5772/intechopen.74654; https://www.sigmaaldrich.com/life-science/biochemicals/biochemical-products.html?TablePage=9616613; and U.S. Pat. No. 4,818,795 to Denzinger, et al. In some preferred forms, the polymer is not a biopolymer. There are three main classes of biopolymers, classified according to the monomers used and the structure of the biopolymer formed: polynucleotides (including DNA and RNA), polypeptides, and polysaccharides that are produced by cells of living organisms. The activated polymer(s) are reactive intermediates that can spontaneously react with the reactive groups of the dye in a subsequent reaction, such that the dye is covalently linked to the polymer structure, such as the backbone of the polymer.

Suitable reactive groups in the polymer include, but are not limited to, a halogen (e.g. fluorine, chlorine, bromine, or iodine), an amino group, a carboxyl group, a carboxamide group, and a hydroxyl group. In some forms, the polymer that can be labeled using the disclosed methods contains a plurality of subunits, where at least one subunit contains a carboxyl group, optionally more than one carboxyl group. In some forms, the polymer that can be labeled using the disclosed methods contains a plurality of subunits, where each of the plurality of subunits contains a carboxyl group, optionally more than one carboxyl group. In some forms, the polymer that can be labeled using the disclosed methods contains a plurality of subunits, where two or more subunits contain a carboxyl group, optionally each of the two or more subunits contains a carboxyl group. For example, the polymer that can be labeled using the disclosed methods contains a plurality of subunits, where at least one subunit contains a functional group that can be converted to a carboxyl group, optionally more than one functional group that can be converted to carboxyl groups. In some forms, the polymer that can be labeled using the disclosed methods contains a plurality of subunits, where each of the plurality of subunits contains a functional group that can be converted to a carboxyl group, optionally more than one carboxyl group. In some forms, the polymer that can be labeled using the disclosed methods contains a plurality of subunits, where two or more subunits contain a functional group that can be converted to a carboxyl group, optionally each of the two or more subunits contain more than one functional group that can be converted to carboxyl groups. Optionally, the functional groups that can be converted to carboxyl groups contained in the polymer may be the same or different. Exemplary functional groups that can be converted to a carboxyl group include, but are not limited to, an ester group, an aldehyde group, and a halogen substituted acyl group (e.g. acyl chloride group).

In some forms, the polymer contains at least one subunit having the structure of formula 8 as shown in the brackets:

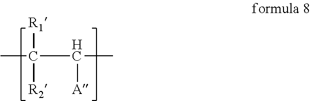

where R₁′ and R₂′ are independently a hydrogen, a substituted or non-substituted alkyl group, a substituted or non-substituted alkenyl group, or a substituted or non-substituted aryl group, and where A″ is a halogen, an amino group, a carboxyl group, a carboxamide group, or a hydroxyl group.

In some forms, the substituent(s) in a substituted alkyl group, a substituted alkenyl group, a substituted aryl group, or a substituted alkyl-aryl group are independently a halogen atom, a sulfonic acid, an azide group, a cyanate group, an isocyanate group, a nitrate group, a nitrile group, an isonitrile group, a nitrosooxy group, a nitroso group, a nitro group, an aldehyde group, an alkoxy group, an acyl halide group, a carboxylic acid group, a carboxylate group, an alkyl group, a heteroalkyl group, an alkenyl group, a heteroalkenyl group, an alkynyl group, a heteroalkynyl group, an aryl group, a heteroaryl group, polyaryl group, a heteropolyaryl group, a alkylaryl group, an amino group, an ester group, a hydroxyl group, a thiol group, a sulfonyl group, an amide group, an azo group, an acyl group, a carbonyl group, a carbonate ester group, an ether group, an aminooxy group, or a hydroxyamino group.

In some forms, R₁′ and R₂′ are independently a hydrogen, a substituted or non-substituted C₁-C₂₀ alkyl group, a substituted or non-substituted C₁-C₁₅ alkyl group, a substituted or non-substituted C₁-C₁₂ alkyl group, a substituted or non-substituted C₁-C₁₀ alkyl group, a substituted or non-substituted C₁-C₆ alkyl group, a substituted or non-substituted C₁-C₄ alkyl group, a substituted or non-substituted C₁-C₃ alkyl group, an ethyl group, or a methyl group. In some forms, at least one of R₁′ and R₂′ is a hydrogen. In some forms, both R₁′ and R₂′ are hydrogen.

In some forms, A″ is a carboxyl group.

In some forms, the polymer contains a structure of any one of formulae 13-16.

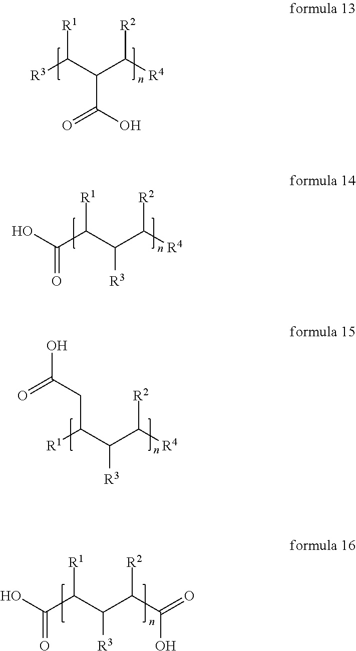

where R¹, R², R³, and R⁴ can be any of the functional groups defined above for R₁′, R₂′, and A″, and where n can be a positive integer at least 1, at least 10, at least 20, at least 50, at least 100, at least 200, at least 500, at least 1×10³, at least 2×10³, at least 5×10³, at least 1×10⁴, at least 2×10⁴, at least 5×10⁴, at least 6×10⁴, at least 7×10⁴, at least 8×10⁴, up to 1×10⁵, up to 2×10⁵, or up to 3×10⁵.

In some forms, the polymer is a partially hydrolyzed polyacrylamide, an anionic polyacrylamide, or copolymers thereof, or an associative polymer.

An associative polymer generally refers to a copolymer of acrylamide monomer with a hydrophobic monomer that is in an amount from 0.3 mol % to 4 mol % of the polymer. For example, the polymer is a partially hydrolyzed polyacrylamide having the structure of formula 9:

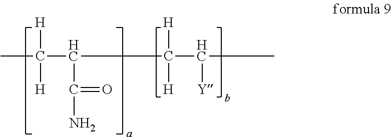

where Y″ is a carboxyl group or a carboxylate group, and where a and b are independently a positive integer at least 1, at least 10, at least 20, at least 50, at least 100, at least 200, at least 500, at least 1×10³, at least 2×10³, at least 5×10³, at least 1×10⁴, at least 2×10⁴, at least 5×10⁴, at least 6×10⁴, at least 7×10⁴, at least 8×10⁴, up to 1×10⁵, up to 2×10⁵, or up to 3×10⁵.

In some forms, the polymer is a copolymer of partially hydrolyzed polyacrylamide containing the structure of formula 10:

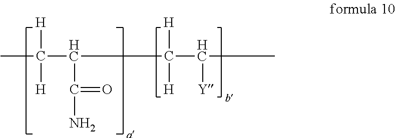

where Y″ is as defined above and where a′ and b′ are independently a positive integer at least 1, at least 10, at least 20, at least 50, at least 100, at least 200, at least 500, at least 1×10³, at least 2×10³, at least 5×10³, at least 1×10⁴, at least 2×10⁴, at least 5×10⁴, at least 6×10⁴, at least 7×10⁴, at least 8×10⁴, up to 1×10⁵, up to 2×10⁵, or up to 3×10⁵.

In some forms, the polymer is an anionic polyacrylamide or a copolymer of anionic polyacrylamide.

The polymer can have any suitable Mw, as long as the polymers can dissolve in water. In some forms, the polymer has a Mw of ≥5 megadalton (MDa), ≥5 MDa, ≥6 MDa, ≥6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa. In some preferred forms, the polymer has a Mw in a range between 5 MDa and 20 MDa, or between 6 MDa and 20 MDa.

### 2. Activation Agents

Typically, the activation agent(s) are soluble in the buffer solution. The activation agent(s) can activate the reactive group(s) of the polymer to form an activated polymer, which is a reactive intermediate that can spontaneously react with the reactive group(s) of the dye in a subsequent reaction.

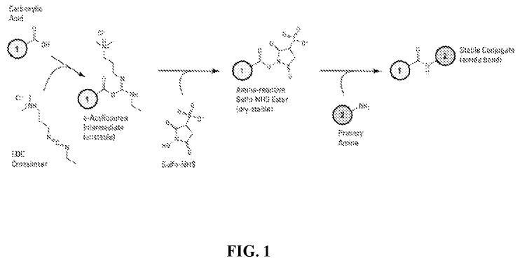

In some forms, the activation of polymer is based on carbodiimide chemistry where the activation agent can be 1-ethyl-3-(3-dimethylaminopropyl) carbodiimide (EDC) or a salt thereof, optionally a mixture of EDC or a salt thereof and N-hydroxysulfosuccinimide (NHS). For example, the carboxyl group(s) of the polymer are activated by EDC or a mixture of EDC and NHS to form a reactive intermediate (or “activated polymer”). In cases wherein EDC or a mixture of EDC and NHS is the activation agent(s), the activated polymer can be a reactive unstable intermediate or a semi-stable NHS ester intermediate described below. A general principle of carboxyl group activation by a mixture of EDC and NHS is shown in FIG. 1 (first two steps). Generally, EDC reacts with the carboxyl group of the polymer and forms a reactive and unstable intermediate. Optionally, the activation agents also include NHS which couples to the unstable intermediate formed from EDC and the carboxyl group of the polymer to form a semi-stable NHS ester intermediate.

Typically, the concentration of the activation agent or the concentration of each activation agent in the mixture of two or more activation agents is in excess of the concentration of the polymer. For example, the concentration (mole/L) of the activation agent, optionally the concentration of each activation agent in the mixture of two or more active agents, is at least 2×10⁵, at least 4×10⁵, at least 10⁶, at least 1.5×10⁶, at least 2×10⁶, at least 2.5×10⁶, at least 3×10⁶, at least 3.5×10⁶, at least 4×10⁶, at least 4.5×10⁶, or at least 5×10⁶ fold of the concentration of the polymer, for example, 5×10⁶ fold of the concentration of the polymer. In some forms, the activation agent used to active the polymer is EDC and the concentration of EDC is at least 4×10⁵, at least 10⁶, at least 1.5×10⁶, at least 2×10⁶, at least 2.5×10⁶, at least 3×10⁶, at least 3.5×10⁶, at least 4×10⁶, at least 4.5×10⁶, or at least 5×10⁶ fold of the concentration of the polymer, for example, 5×10⁶ fold of the concentration of the polymer. In some forms, the activation agents are a mixture of EDC and NHS, where the concentrations of EDC is at least 4×10⁵, at least 10⁶, at least 1.5×10⁶, at least 2×10⁶, at least 2.5×10⁶, at least 3×10⁶, at least 3.5×10⁶, at least 4×10⁶, at least 4.5×10⁶, or at least 5×10⁶ fold of the concentration of the polymer and the concentration of NHS is about half of the concentration of EDC. For example, the activation agents are a mixture of EDC and NHS, where the concentration of EDC is about 5×10⁶ fold of the concentration of the polymer and the concentration of NHS is about 2.5×10⁶ fold of the concentration of the polymer.

The above described concentration of the activation agent or each activation agent in the mixture of two or more activation agents can trigger transient chain bundling of the polymer (i.e. the chains of the polymer molecules bundle together), forming activated polymers in the form of solids that are suspended in the buffer solution i.e., a suspension. The formation of a suspension upon polymer activation results in a transient loss of the viscosity of the mixed buffer solution (i.e. polymer dissolved in buffer solution prior to activation). This change in polymer's viscosifying property allows efficient purification of the activated polymer from the mixture of excess activation agent(s) and the activated polymer.

### 3. Buffer Solution

The activation of polymer is performed in a buffer solution over a range of pHs, such as a pH in a range from about 4 to about 6. For example, the buffer solution has a pH in a range from about 4.5 to about 6, from about 5 to about 6, from about 5 to about 5.5, such as 5.1, 5.2, or 5.3. Optionally, the buffer solution has a pH in a range from about 5 to about 5.5.

Exemplary buffer solutions include, but are not limited to, phosphate buffer, phosphate buffered saline (PBS), acetate buffer, citrate buffer, maleic acid buffer, salt water, MES buffer, Bis-Tris buffer, ADA, ACES, PIPES, MOPSO, Bis-Tris propane, BES, MOPS, TES, HEPES, DIPSO, MOBS, TAPSO, Trizma, HEPPSO, POPSO, TEA, EPPS, Tricine, Gly-gly, Bicine, HEPBS, TAPS, AMPD, TABS, AMPSO, CHES, CAPSO, AMP, CAPS, CABS, or a combination thereof. In some forms, the activation of the polymer is performed in a MES buffer having a pH in a range from about 4 to about 6, from about 4.5 to about 6, from about 5 to about 6, from about 5 to about 5.5, or from about 5.1 to about 5.3.

Typically, the buffer solution can dissolve the polymer(s) (i.e. the polymer(s) are soluble in the buffer solution) to form a mixture containing the buffer solution and the polymer i.e., a mixed buffer solution. The mixed buffer solution has a viscosity that is different from the viscosity of the buffer solution without the polymer(s). For example, the viscosity of the mixed buffer solution is more than the viscosity of buffer solution without the polymer(s) as measured for example, using a rheometer under similar conditions of temperature and pressure.

In some forms, the pH of the buffer solution is adjusted prior to mixing with the polymer(s) and/or the activation agents. For example, the pH of the buffer solution is added with a base solution, such as sodium hydroxide, prior to mixing with the polymer and the activation agents.

### 4. Activated Polymers

Intermediates (also referred herein as “activated polymers”) are formed from reaction between the functional groups of the polymer and an activation agent, optionally a mixture of two or more activation agents. The activated polymer(s) are reactive intermediates that can spontaneously react with the reactive groups of the dye in a subsequent reaction described below, such that the dye is covalently linked to the polymer structure, such as the backbone of the polymer. Typically, the activated polymers have a different physical property from the polymer prior to activation. In some preferred forms, the activated polymers have a different viscosifying property from the polymer prior to activation. For example, upon activation by an activation agent, the polymer, which is soluble in the buffer solution, bundles (i.e. polymer chain bundling) and forms activated polymer in a solid form that is suspended in the buffer solution.

In some forms, the activated polymer is formed based on carbodiimide chemistry where the activation agent can be 1-ethyl-3-(3-dimethylaminopropyl)carbodiimide (EDC) or a salt thereof, optionally a mixture of EDC or a salt thereof and N-hydroxysulfosuccinimide (NHS). In these forms, EDC or a mixture of EDC and NHS activates the carboxyl group(s) of the polymer to form the activated polymer, which can be a reactive unstable intermediate or a semi-stable NHS ester intermediate. For example, EDC reacts with the carboxyl group of the polymer and forms a reactive and unstable intermediate (see FIG. 1, first step). Optionally, the activation agents also include NHS which couples to the unstable intermediate formed from EDC and the carboxyl group of the polymer to form a semi-stable NHS ester intermediate (see FIG. 1, second step).

B. Mixing the Activated Polymer(s) with Dye(s) to Form Dye-Labeled Polymer(s)

Generally, the activated polymer(s) is/are mixed with a dye in a buffer solution to form dye-labeled polymer(s). Any of the buffer solutions described above may be used, but typically have a pH in a range that is different from the pH of the buffer solution used in the activation process. For example, the buffer solution for the reaction between the activated polymer(s) and the dye has a pH in a range from about 6.5 to about 8, from about 7 to about 8, from about 6.5 to about 7.5, or from about 7 to about 7.5, such as a pH of about 7.4. In some forms, the reaction between the activated polymer(s) and the dye is performed in a PBS having a pH in a range from about 6.5 to about 8, from about 7 to about 8, from about 6.5 to about 7.5, or from about 7 to about 7.5, such as a pH of about 7.4. Typically, the activated polymer(s) are suspended in the buffer solution upon mixing with the buffer solution.

The activated polymer(s) and the dye may be mixed with the buffer solution simultaneously, substantially simultaneously, or sequentially. In some forms, the activated polymer(s) and the dye are mixed with the buffer solution sequentially. For example, the buffer solution is added to the activated polymer(s) first to first form a suspension and the dye is then added into the suspension to form a reaction mixture. In some preferred forms, the dye is in the form of a solution and the dye solution is added to the suspension dropwise.

The dye-labeled polymer is formed by the reaction between the activated polymer and a reactive group of the dye that forms a covalent bond between the activated polymer and the dye. For example, the reaction between the activated polymer and a reactive group of the dye forms an amide bond between the activated polymer and the dye that links the dye to the polymer structure. In some forms, the dye-labeled polymer contains or has a structure of any one of formulae 1-7 described above. Typically, the dye-labeled polymer(s) remain as a solid form. Optionally, the dye-labeled polymer(s) are dried and soaked in an aqueous solvent to gain the viscosifying property that is the same or substantially the same as the polymer prior to labeling. Such forms are described below.

The reaction between the activated polymer(s) and the dye to form the dye-labeled polymer(s) is typically performed at room temperature, i.e. 20-22° C., under atmospheric pressure. Typically, the period of time sufficient to form the dye-labeled polymer is up to about 48 hours, up to about 36 hours, up to about 24 hours, up to about 20 hours, up to about 15 hours, up to about 12 hours, at least about 8 hours, at least 9 hours, at least 10 hours, in a range from about 8 hours to about 48 hours, from about 8 hours to about 36 hours, from about 8 hours to about 24 hours, from about 8 hours to about 20 hours, from about 8 hours to about 15 hours, or from about 8 hours to about 12 hours. For example, the reaction between the activated polymer(s) and the dye to form the dye-labeled polymer(s) is typically performed at room temperature, i.e. 20-22° C., under atmospheric pressure, for a period of time of up to about 48 hours, up to about 36 hours, up to about 24 hours, up to about 20 hours, up to about 15 hours, up to about 12 hours, at least about 8 hours, at least about 9 hours, at least about 10 hours, in a range from about 8 hours to about 48 hours, from about 8 hours to about 36 hours, from about 8 hours to about 24 hours, from about 8 hours to about 20 hours, from about 8 hours to about 15 hours, or from about 8 hours to about 12 hours. Typically, the reaction between the activated polymer(s) and the dye is performed in dark to avoid photo-bleaching of the dye, such as covering the reaction mixture with aluminum foil to block light. For example, the reaction between the activated polymer(s) and the dye is performed at room temperature for a period of time up to 15 hours, where the reaction mixture was covered with aluminum foil.

### 1. Dyes

The dyes that can be used in the method disclosed herein contain a reactive group that can react with the activated polymer to form dye-labeled polymer, such that the dye is covalently linked to the polymer structure, such as the backbone of the polymer.

Suitable reactive groups of the dye include, but are not limited to, a halogen (e.g. fluorine, chlorine, bromine, or iodine), an amino group, a carboxyl group, a carboxamide group, and a hydroxyl group. For example, the dye used in the disclosed methods contains an amino group, optionally more than one amino group, to react with the activated polymer that is activated based on carbodiimide chemistry, such that a stable amide bond is formed between the dye and the polymer. In some forms, the dye used in the disclosed methods contains a primary amino group, optionally more than one primary amino group, to react with the activated polymer that is activated based on carbodiimide chemistry, such that a stable amide bond is formed between the dye and the polymer (see, e.g., FIG. 1, step 3).

In some forms, the dye is a fluorescent dye having the structure of formula 11:

D′-A′″ formula 11

where D′ is a fluorophore and where A′″ is a halogen, an amino group, a carboxyl group, a carboxamide group, or a hydroxyl group.

Suitable fluorophores that can be used to label the polymer include, but not limited to, methoxycoumarin, dansyl, pyrene, ALEXA FLUOR® 350, AMCA, marina blue dye, dapoxyl dye, dialkylaminocoumarin, bimane, hydroxycoumarin, cascade blue dye, pacific orange dye, ALEXA FLUOR® 405, cascade yellow dye, pacific blue dye, PyMPO, ALEXA FLUOR® 430, NBD, QSY 35, fluorescein, ALEXA FLUOR® 488, oregon green 488, BODIPY 493/503, rhodamine green dye, BODIPY FL, 2′, 7′-dichloro-fluorescein, oregon green 514, ALEXA FLUOR® 514, 4′,5′-Dichloro-2′,7′-dimethoxy-fluorescein, eosin, rhodamine 6G, BODIPY R6G, ALEXA FLUOR® 532, BODIPY 530/550, BODIPY TMR, ALEXA FLUOR® 555, tetramethyl-rhodamine, ALEXA FLUOR® 546, BODIPY 558/568, QSY 7, QSY 9, BODIPY 564/571, lissamine rhodamine B, rhodamine red dye, BODIPY 576/589, ALEXA FLUOR® 568, X-rhodamine, BODIPY 581/591, BODIPY TR, ALEXA FLUOR® 594, texas red dye, naphthofluorescein, ALEXA FLUOR® 610, BODIPY 630/650, malachite green, ALEXA FLUOR® 633, ALEXA FLUOR® 635, BODIPY 650/665, ALEXA FLUOR® 647, QSY 21, ALEXA FLUOR® 660, ALEXA FLUOR® 680, ALEXA FLUOR® 700, ALEXA FLUOR® 750, and ALEXA FLUOR® 790.

In some forms, A′″ is an amino group, optionally a primary amino group. For example, the dye is a fluorescent dye having the structure of formula 12:

D′—NH₂ formula 12

where D′ can be any one of the fluorophores described above.

### C. Additional Steps

In addition to the steps described above, which include: step (i) mixing the polymer with an activation agent, optionally a mixture of two or more activation agents, in a first buffer solution, where upon activation, the polymer bundles in the first buffer solution and forms an activated polymer in the first buffer solution, and step (ii) mixing the activated polymer with the dye in a second buffer solution to form a dye-labeled polymer in the second buffer solution, the method may include one or more additional steps described below. Typically, the polymer is in the form of a polymer solution.

The additional steps can occur prior to step (i), subsequent to step (i) but prior to step (ii), and/or subsequent to step (ii).

1. Preparing Polymer Solution and/or Activation Agent Solution

The method can include a step of preparing a polymer solution and/or an activation agent solution prior to step (i). The polymer and/or active agent(s) are added in the buffer solution in the form of a solution (i.e. polymer solution and/or activation agent solution) in step (i).

To prepare the polymer solution, a polymer in a solid form, optionally in the form of a powder, film, or tablet, is added into an aqueous solvent. The polymer are soluble in the aqueous solvent. The aqueous solvent can be water, such as deionized water, or a buffer solution as described above. For example, the aqueous solvent is deionized water or the same buffer as used in step (i) that can dissolve the polymer.

In some forms, the polymer is added into the aqueous solvent under stirring, optionally, the stirring is continued after polymer addition for a period of time to ensure sufficient dissolution of the polymer in the aqueous solvent. For example, the polymer in the form of a powder is added to deionized water under stirring and the stirring was kept for about 2 hours to ensure sufficient dissolution of the polymer in the deionized water.

In some forms, the polymer solution is kept at room temperature for at least 3 hours, at least 5 hours, at least 10 hours, at least 12 hours, at least 15 hours, at least 24 hours, up to 3 days, up to 2 days, between 3 hours and 48 hours, or between 3 hours and 36 hours, such as 24 hours, prior to step (i) to ensure complete hydration of polymer molecules. For example, the polymer solution is kept at room temperature for about 24 hours to ensure complete hydration of the polymer molecules prior to mixing with activation agents in a buffer solution.

To prepare the activation agent solution, an active agent or a mixture of two or more active agents in a solid form, optionally in the form of a powder, film, or tablet, is added into an aqueous solvent. The active agent(s) are soluble in the aqueous solvent. The aqueous solvent can be water, such as deionized water, or a buffer solution as described above. For example, the aqueous solvent is deionized water or the same buffer as used in step (i) that can dissolve the active agent(s).

### 2. Purifying the Activated Polymer(s)

The method can include a step of purifying the activated polymer after step (i) and prior to step (ii). The purification step can remove excess activation agent(s) (i.e. unreacted activation agent(s)) from the mixture of the activated polymer and the excess activation agent(s).

The activated polymer formed in step (i) is in solid form and suspended in the buffer solution, allowing efficient purification of the activated polymer. The activated polymer can be purified using any purification technique, such as centrifugation, filtration, dialysis, or an alumina column. In some preferred forms, the activated polymer is purified by centrifugation. Upon centrifugation, the activated polymers in solid form precipitate out of the buffer solution into a pellet which collects at the bottom of the centrifugation tube and the excess activation agents remain dissolved in the buffer solution (i.e. supernatant). The excess activation agents can be removed by decanting the supernatant.

In some forms, the step of purifying the activated polymer includes: (a) centrifuging the buffer solution containing the activated polymer to produce a precipitate (pellet) and a supernatant, and (b) decanting the supernatant to separate the precipitate (pellet) and the supernatant. The precipitate contains the activated polymer and the supernatant contains the excess activation agent(s).

The centrifugation can be performed at a speed in a range from 3000 rpm to 5000 rpm for a period of time from 3 minutes to 20 minutes. For example, the buffer solution containing the activated polymer and excess activation agent(s) is centrifuged at about 4000 to 4500 rpm for about 10-20 minutes, such as, centrifuged at about 4000, 4100, 4200, 4300, 4400, or 4500 rpm, for 10, 11, 12, 13, 14, 15, 16, 17 18 or 19 minutes. The supernatant can be decanted using a known technique, such as pipetting or pouring. For example, the supernatant is removed using a pipette.

Optionally, following decanting the supernatant, the precipitates containing the activated polymer is collected and dried to provide the activated polymer in a solid form. The precipitates containing the activated polymer may be in the form of a powder, a tablet, or a film. For example, the precipitates are in the form of a tablet and is dried by tapping it over them over a tissue to remove any remaining liquid to provide the purified activated polymer.

### 3. Purifying the Dye-labeled Polymer(s)

The method can include a step of purifying the dye-labeled polymer subsequent to step (ii). The purification step can remove excess dye (i.e. unreacted dye) from the mixture of the dye-labeled polymer and the excess dye.

The dye-labeled polymer formed in step (ii) is in solid form and suspended in the buffer solution, allowing efficient purification of the dye-labeled polymer. The dye-labeled polymer can be purified using any one of the purification techniques described above. In some preferred forms, the dye-labeled polymer is purified by centrifugation. For example, upon centrifugation, the dye-labeled polymer in solid form can precipitate out of the buffer solution and the excess dye remains dissolved in the buffer solution (i.e. supernatant). The excess dye can be removed by decanting the supernatant.

In some forms, the step of purifying the dye-labeled polymer includes: (a) centrifuging the buffer solution containing the dye-labeled polymer to produce a precipitate and a supernatant, and (b) decanting the supernatant to separate the precipitate and the supernatant. The precipitate contains the dye-labeled polymer and the supernatant contains the excess dye.

The centrifugation can be performed at a speed in a range from 3000 rpm to 5000 rpm for a period of time from 3 minutes to 20 minutes. For example, the buffer solution containing the dye polymer and excess dye is centrifuged at about 4000 to 4500 rpm for about 10-20 minutes, such as, centrifuged at about 4000, 4100, 4200, 4300, 4400, or 4500 rpm, for 10, 11, 12, 13, 14, 15, 16, 17 18 or 19 minutes. The buffer solution containing the dye-labeled polymer and excess dye is centrifuged at about 4200 rpm for about 15 minutes. The supernatant can be decanted using a known technique, such as pipetting or pouring. For example, the supernatant is removed using a pipette.

Optionally, following decanting the supernatant, the precipitates containing the dye-labeled polymer is collected and dried to provide the dye-labeled polymer in a solid form. The precipitates containing the dye-labeled polymer may be in the form of a powder, a tablet, or a film. For example, the precipitates are in the form of a tablet and is dried by tapping it over a tissue to remove any remaining liquid to provide the purified dye-labeled polymer.

4. Washing the Precipitates The method can include a step of washing the dye-labeled polymer subsequent to the step of purifying the dye-labeled polymer, to remove any remaining impurities, such as unreacted dye molecules and remaining salt(s) of the buffer solution. The purified dye-labeled polymer can be purified using a known washing technique. In some preferred forms, the purified dye-labeled polymer is washed using centrifugation with a washing solvent. The washing solvent may be an aqueous solvent, such as water or a buffer solution described above. For example, the washing solvent is PBS at pH 7.4.

In some forms, the step of washing the dye-labeled polymer includes: (a) mixing the purified dye-labeled polymer with the washing solvent to form a suspension, (b) centrifuging the suspension containing the dye-labeled polymer to produce a product precipitate and a waste supernatant, and (c) decanting the waste supernatant to separate the product precipitate and the waste supernatant. The product precipitate contains the dye-labeled polymer and the waste supernatant contains any remaining impurities, such as unreacted dye molecules.

The centrifugation can be performed at a speed in a range from 3000 rpm to 5000 rpm for a period of time from 3 minutes to 20 minutes. For example, the buffer solution containing the dye-labeled polymer and any remaining impurities is centrifuged at about 4000 to 4500 rpm for about 10-20 minutes, such as, centrifuged at about 4000, 4100, 4200, 4300, 4400, or 4500 rpm, for 10, 11, 12, 13, 14, 15, 16, 17 18 or 19 minutes. The suspension containing the dye-labeled polymer and any remaining impurities is preferably centrifuged at about 4200 rpm for about 15 minutes.

The waste supernatant can be decanted using a known technique, such as pipetting or pouring. For example, the waste supernatant is removed using a pipette. Optionally, following decanting the waste supernatant, the product precipitates containing the washed dye-labeled polymer is collected and optionally tapped over a tissue to provide the washed dye-labeled polymer. The precipitates containing the dye-labeled polymer may be in the form of a powder, a tablet, or a film.

Steps (a)-(c) may be repeated for at least one time, at least two times, at least three times, or at least five times. For example, steps (a)-(c) are repeated one time, two times, three times, four times, or five times. Each repeated washing step uses the dye-labeled polymer collected from the previous washing. This step is followed in some forms by addition of an appropriate amount of water sufficient to allow for effective sonication of the dye-labeled polymer precipitate, for example, 0.5-3 ml of water, such as 1 ml, 1.5 ml, 2 ml, etc.

### 5. Sonication and Optional Drying the Dye-Labeled Polymer(s)

The method includes sonicating preferably using an ultrasonic probe sonicator, for 5 s, and up to 1-2 mins. Preferably, sonification eliminates the need for an additional step of drying overnight and soaking the polymers to disperse the molecules. This discovery eliminates the need to dry the polymeric precipitates overnight in the oven under vacuum at 40° C. and −30 kPa, followed by soaking the precipitates in water to allow slow hydration such that the polymer molecules dispersed in the solution and the solution gains viscosity.

However, the method can optionally include a step of drying the dye-labeled polymer subsequent to step (ii) or an optional step described above. For example, the drying step is performed subsequent to step (ii), subsequent to the step of purifying the dye-labeled polymer, or subsequent to the step of washing the dye-labeled polymer.

The dye-labeled polymer can be dried using a known technique. For example, the dye-labeled polymer is air-dried, in a vacuum oven, or using a dehydrating agent, or a combination thereof. A dehydrating agent is chemical compound that dries or removes water from a substance. Suitable dehydrating agent can be used for drying the dye-labeled polymer include, but are not limited to, aluminum phosphate, methyl N-(triethylammoniumsulfonyl)carbamate, calcium oxide, cyanuric chloride, N,N′-Dicyclohexylcarbodiimide, iron(III) chloride, orthoformic acid, phosphorus pentoxide, phosphoryl chloride, sulfuric acid, or a combination thereof.

In some forms, the dye-labeled polymer is dried in a vacuum oven under suitable conditions (e.g. temperature, pressure, and time period) to remove any remaining liquid. The drying conditions in the vacuum oven, such as temperature, pressure, and time period, are selected based on the polymer. For example, the temperature, pressure, and time period for dying the dye-labeled polymer in a vacuum oven are selected to avoid thermal degradation of the dye-labeled polymer. In some forms, the dye-labeled polymer is dried in a vacuum oven at a temperature in a range from 25° C. to 40° C., under a pressure in a range from −15 kPa to −30 kPa, for a time period from 8 hours to 48 hours. For example, the dye-labeled polymer is dried in a vacuum oven at about 40° C., under −30 kPa, for overnight (i.e. about 10-15 hours).

### 6. Soaking the Dye-Labeled Polymer(s) in a Soaking Solvent

The method can optionally include a step of soaking the dye-labeled polymer in an aqueous solvent subsequent to step (ii) or an optional step described above. For example, the soaking step is performed subsequent to step (ii), subsequent to the step of purifying the dye-labeled polymer, subsequent to the step of washing the dye-labeled polymer, or subsequent to the step of drying the dye-labeled polymer. The soaking solvent may be any suitable polar solvent, such as an aqueous solvent (e.g. water and aqueous buffer) and DMSO. In some preferred forms, the soaking solvent is an aqueous solvent, such as water. The soaking step disperses the bundled polymer (i.e. disperse the bundled polymer chains into single polymer chains) and recover the polymer's viscosifying property.

Soaking the dye-labeled polymer can reverse the chain bundling of the polymer occurred in step (i). The viscosity of a polymer solution is attributed to the polymer being dispersed in an aqueous solvent as single molecules and forming hydrogen bonds with the water molecules of the aqueous solvent. If polymer bundles, it doesn't have proper viscosifying property to form hydrogen bonds with water molecules. Therefore, reversal of the chain bundling of the polymer can recover the viscosifying property of the polymer, such that the dye-labeled polymer has a viscosifying property the same or substantially the same as the polymer prior to labeling. For example, the viscosity of a solution prepared by dissolving a dye-labeled polymer in an aqueous solvent, such as water or a buffer solution, is the same or substantially the same as a solution prepared by dissolving the same amount in moles of the polymer prior to labeling with the dye in the same aqueous solvent.

In some forms, the dye-labeled polymer is mixed with an aqueous solvent and soaked in the aqueous solvent for a sufficient period of time, at a temperature in a range from room temperature to 65° C., from 25° C. to 65° C., from 30° C. to 65° C., from 35° C. to 65° C., from 40° C. to 65° C., from 45° C. to 65° C., from 50° C. to 65° C., or from room temperature to 40° C., to achieve a desired solution viscosity. A desired solution viscosity means that the viscosity of the dye-labeled polymer solution is the same or substantially the same as a polymer solution containing the same amount in moles of the polymer prior to labeling in the same aqueous solvent. The period of time sufficient for achieving the desired solution viscosity is up to 72 hours, up to 48 hours, up to 36 hours, up to 24 hours, at least 8 hours, at least 10 hours, at least 12 hours, at least 15 hours, in a range from 8 hours to 72 hours, from 10 hours to 72 hours, from 12 hours to 72 hours, from 15 hours to 72 hours, from 20 hours to 72 hours, from 24 hours to 72 hours, or from 48 hours to 72 hours.

In some forms, the dye-labeled polymer is soaked in water at a temperature in a range from room temperature to 65° C., from 25° C. to 65° C., from 30° C. to 65° C., from 35° C. to 65° C., from 40° C. to 65° C., from 45° C. to 65° C., from 50° C. to 65° C., or from room temperature to 40° C., for a time period up to 72 hours, up to 48 hours, up to 36 hours, up to 24 hours, at least 8 hours, at least 10 hours, at least 12 hours, at least 15 hours, in a range from 8 hours to 72 hours, from 10 hours to 72 hours, from 12 hours to 72 hours, from 15 hours to 72 hours, from 20 hours to 72 hours, from 24 hours to 72 hours, or from 48 hours to 72 hours, to achieve the desired solution viscosity. For example, the dye-labeled polymer is soaked in water at a temperature of about 60° C. or 65° C. for overnight (i.e. 10-15 hours) to achieve the desired solution viscosity. For example, the dye-labeled polymer is soaked in water at a temperature of about 25° C. for a period of time from 48 hours to 72 hours to achieve the desired solution viscosity.

### III. Methods of Using

The disclosed dye-labeled polymers can be used in the oil and environmental industries. For example, the dye-labeled polymers are used in oil recovery, wastewater, removing metal ions and phosphates from dilute solutions, coagulant in the treatment of solid-containing water, etc.

In some forms, the disclosed dye-labeled polymers are used in studies of the change of polymer properties, such as viscosity and conformational, during oil recovery, wastewater, removing metal ions and phosphates from dilute solutions, coagulant in the treatment of solid-containing water.

In some forms, the disclosed dye-labeled polymers can be used in advanced visualization techniques such as single-molecule tracking and super-resolution imagining, for visual characterization in the field of synthetic polymers. For example, the dye-labeled polymers can provide information on the polymer characteristics, such as the conformation characteristics of the polymers to assist in structural design of polymers (WO 03/062349 by Warshawsky; Turro and Arora, Polymer, 27(5):783-796 (1986); and Ricka, et al., Macromolecules, 20(6):1407-1411 (1987)).

In some forms, the disclosed dye-labeled polymers can be used for tracking and monitoring the behavior of these polymers in oil recovery. For example, polymer tracing or tracking using the disclosed dye-labeled polymer in oil recovery provides information on polymer solution flow route or concentrations (U.S. Pat. No. 5,128,419 to Fong and U.S. Pat. No. 5,986,030 to Murray and Whipple).

In some forms, the disclosed dye-labeled polymers can be used for monitoring and/or determining the level of these polymers in water industry, particularly polymers at low levels, such as parts per million (ppm) (U.S. Pat. No. 6,312,644 to Moriarty, et al. and U.S. Pat. No. 5,986,030 to Murray and Whipple). In some forms, the disclosed dye-labeled polymer can be used in manufacturing industry for the detection of polymer-coated products (U.S. Pat. No. 5,986,030 to Murray and Whipple and U.S. Pat. No. 4,813,973 to Winnik and Borg).

The present invention will be further understood by reference to the following non-limiting examples.

### EXAMPLES

### Example 1. Synthesis of Fluorescently Labeled Partially Hydrolyzed Polyacrylamide

### Materials and Methods

### Materials

The labeling method utilized a water-soluble ultra-high molecular weight synthetic polymer (i.e. a partially hydrolyzed polyacrylamide of 20 MD, also referred herein as “HPAM”) and the fluorescent dye, a primary amine.

### Procedures for Labeling Partially Hydrolyzed Polyacrylamide

The labeling method was based on a two-step reaction of EDC/NHS crosslinking of carboxylates, namely the polymer, with primary amines, namely the fluorescent dye.

EDC and NHS, in approximate 5 million-fold excess to polymer concentration, were used to prepare amine-reactive esters of carboxylates groups for chemical labeling. In the first step, the carboxyl (—COOH) sites of the polymer were reacted with the NHS in the presence of EDC, resulting in a semi-stable NHS ester. This activation reaction was performed in MES buffer at a pH around 5 and gently stirred on a magnetic plate at 500 rpm for a time interval of approximately 5-40 mins preferably, about 10-20 mins. Afterwards, the excess unreacted amounts of EDC and NHS were removed by centrifugation for 15 minutes at 4200 rpms, to prepare for conjugation of the semi-stable NHS ester with the fluorescent compound.

In the second step, the semi-stable amine-reactive NHS ester reacted with the primary amine (—NH₂) (i.e. the primary amine of the fluorescent dye) in a phosphate buffer at a pH raised to 7.4. The mixture was left stirring on the magnetic stirrer at 500 rpm overnight, in dark. The reaction completed the tagging process by forming the stable amide bond, producing the fluorescent-labeled polymer. The resulted labelled polymer was purified from the unreacted dye by washing with phosphate buffer for 3 times and centrifuging at the same conditions as described in the first step. The polymer molecules were soaked in an aqueous solvent such as water, and then sonicated for 5 s, but can be sonicated for up to 1-2 mins using an ultrasonic probe sonicator. The fluorescent-labeled polymers can optionally be dried at 40° C. under high vacuum overnight. The dried polymer molecules were soaked in an aqueous solvent to recover the viscosity of the polymer, generating a viscous polymer solution.

### HPAM Polymer Solution Preparation (24 h Prior to Labeling)

The polymer solution containing 20 MDa powdered polymers was prepared following a standard protocol from the producer company SNF:
Deionized water was placed in a larger beaker.
The paddle stirrer (mechanical stirrer) was set at a high rate to create a strong vortex, 700 rpm.
The 20 MDa powdered polymer was added to the deionized water slowly (crystal by crystal) by sprinkling it into the wall of the vortex.
After a stirring at 700 rpm, the vortex rate was reduced to 500 rpm to allow sufficient stirring.
The mixture was allowed to stir for 2 hours and allowed to sit still for approximately an additional 24 h for complete hydration of the polymer molecules.
The obtained polymer solution was filtrated through a 1.5 μm filter.

### First Step Reaction:

1 ml MES (5×) was mixed with 4 ml water and pH was adjusted to 5.1-5.3 by adding about 5 μl of NaOH of 10M in the MES buffer solution.
The MES buffer solution was poured in a glass vial placed on the magnetic stirrer at 500 rpm.
1.5 ml polymer solution (1000 ppm) was added in the MES buffer solution drop by drop.
The mixed solution was stirred for about 5 min or until the MES buffer solution and the polymer solution were mixed.
Activation solution was prepared according to the following recipe:
   12.5 mg NHS powder
   50 mg EDC powder
   1 ml water

The activation solution was gently shaken until mixed.
The activation solution was added dropwise to the mixed solution to form a reaction solution.
The reaction solution was stirred for 20 minutes and forms a cloudy suspension.

### Purification:

After stirring, the reaction solution was placed in a centrifuge tube and centrifuged at 4200 rpm for 15 minutes.
After centrifugation, the supernatant was decanted gently to remove the solution and the tube was tapped over a tissue to remove any remaining solution (due to the surface tension of water, a small droplet was formed at the edge of the opening of the tube; the opening of the tube was tapped over the tissue to remove the formed droplet).

### Second Step Reaction

3 ml PBS (1×) at pH 7.4 was added to the precipitates.
The PBS was shaken and pipetted off until the precipitated polymer was dispersed and the suspension was cloudy again.
The mixture was poured back in the glass vial placed on the magnetic stirrer at 500 rpm.
10 μl dye at 1 nM concentration was added to the mixture, dropwise.
The glass vial was covered with aluminum foil and left overnight.

### Purification:

After reacting for overnight, the mixture was placed in a centrifuge tube and centrifuged at 4200 rpm for 15 minutes.
Blue clear solution and polymeric material precipitated at the bottom of the tube were observed.
The supernatant was decanted gently and the tube was tapped over a tissue to remove any remaining solution. Note: all remaining liquid in the vial was removed with a small pipette.
3 ml PBS (1×) at pH 7.4 was added to the polymer precipitates.
The mixture was centrifuged at 4200 rpm for 15 minutes.
Transparent clear solution and blue polymeric material precipitated at the bottom of the tube were observed.
The supernatant was gently decanted and the tube was tapped over a tissue to remove any remaining solution. Note: all remaining PBS in the vial was removed with a small pipette.
1.15 ml of water was added to the tube.

### After-Labeling Sonication

The samples are sonicated for 5 s (and optionally, up to 1-2 minutes. The present experiments showed that by sonicating the sample few seconds (up to 1-2 minutes) this successfully disperses the polymer material in single molecules. Therefore, there is no need for an additional step of drying overnight and soaking the polymers to disperse the molecules. This discovery eliminates the need to dry the polymeric precipitates overnight in the oven under vacuum at 40° C. and −30 kPa, followed by soaking the precipitates in water to allow slow hydration such that the polymer molecules dispersed in the solution and the solution gains viscosity.

### Optional After-Labeling Drying

The polymeric precipitates can be dried overnight in the oven under vacuum at 40° C. and −30 kPa.
The dried polymeric precipitates are soaked in water to allow slow hydration such that the polymer molecules dispersed in the solution and the solution gains viscosity.

### Characterization of Fluorescently Labeled Polymer

The fluorescently labeled partially hydrolyzed polyacrylamide of 20 Mw was confirmed using four different techniques: (1) atomic force microscopy (AFM), (2) Fourier-transform infrared spectroscopy (FTIR), (3) ultraviolet-visible spectroscopy, and (4)single-molecule fluorescence microscopy.

### Results

The exemplary method described herein is scalable and uses commercially available polymers and fluorescent dyes. It minimizes the reaction steps and the time required for the reactions, as well as employs simple equipment (magnetic stirrer and centrifuge). In addition, unlike the existing methods, the reactions in this method can occur under mild conditions (such as room temperature, atmospheric pressure, and gentle mixing) to avoid polymer damage. Accordingly, this is a facile method for labelling water-soluble ultra-high molecular weight polymers containing carboxyl groups through carbodiimede chemistry. The process includes the reaction of amine dyes with the polymer in an aqueous solvent, to attach the dye molecule to the carboxyl groups.

Carbodiimide chemistry (EDC/NHS labelling) is a common method to tag proteins and nanoparticles (such as carbon nanotubes) with carboxylic acid residues. The principle of carbodiimide conjugation is based on carboxyl groups' activation for reaction with primary amines through amide bond formation, as shown in FIG. 1. In simple terms, the EDC reacts with the carboxylic acid and forms an active but unstable intermediate. Consequently, EDC couples NHS to carboxyls, resulting in a semi-stable NHS ester. The addition of NHS, which is optional, allows for a more efficient conjugation to primary amines. The reaction of the ester with the primary amines completes the labelling process by forming a stable amide bond between the two molecules.

The existing carbodiimide crosslinking method for polymers with higher molecular weight (e.g. 5-6 MDa) (WO 03/062349 by Warshawsky), which uses only EDC and excludes NHS reactant, has the following problems: (1) difficulties in the removal of excess reagents and fluorescent probe, (2) difficulty in the resuspension of the labelled polymers and (3) challenges in the preservation of the physical characteristics of the original polymers. Labeling the long chains of synthetic polymers with the molecular weight in the order of tens MDa is generally challenging. The modified, tailored EDC/NHS labeling method described herein provides effective synthesis of high and ultra-high molecular weight fluorescent polymers while preserve their viscosifying properties.

The method is based on the crosslinking of carboxylates with primary amines, and its applicability is not limited to partially hydrolyzed polyacrylamides (HPAM), but can be extended to anionic polyacrylamides, associative polymers (which benefit of booming interest in oilfield applications) and other polymers containing carboxyl groups or functional groups that can be functionalized into carboxyls.

The key process of the method is using high EDC/NHS concentrations to activate transient chain bundling of the HPAMs. In the standard protocols of labeling proteins and nanoparticles, such as CNT, the molar ratio of EDC and the substrate follows a stoichiometry of 1:10. This stoichiometry is enough to efficiently activate the hydroxyl group and react with the primary amine (Thermo Fisher Scientific Inc., 0747(24500):1-4 (2011)). However, this concentration is not sufficient to generate the chain transformation.

For example, when using the standard carbodiimide protocol or with modifications (e.g., reaction time, EDC/NHS concentration—up to 300 000× excess to polymer concentration, etc.), different purification methods to purify the activated polymer or dye-labeled polymer to remove excess reagents or dye tested are as follows.
1. Centrifugation: the mixture was centrifuged with 10 k, 5 k, or 3 k molecular weight membrane filter at different rpm ranges. All of the activated polymer or dye-labeled polymer stick to the membrane filter (some chains pass through the membrane at high centrifugation speed even though the mesh size was 3-4 orders of magnitude smaller). This could be related to a well-known property of these polymer to exhibit high shear-thinning behavior and massive stretch under shear.
2. Mild vacuum filtration: the mixture was filtrated with 10 k, 5 k, or 3 k molecular weight membrane filter under mild vacuum filtration. The polymers stick to the tubes and also passing through the membrane.
3. Dialysis: due to their sticky nature, polymer molecules blocked the dialysis membrane and prevented the exchange even with 100 KD MWCO.
4. Alumina column: the fluorescent dye was adsorbed on the alumina (indicated by the blue color of the dye) but polymer molecules were not visible under the epifluorescent microscope with molecule-scale resolution. Possible explanations could be that polymer molecules were adsorbed along with the dye on the alumina surface and is difficult to be freed.
5. Alumina powder for absorbing excess dye: mixture was shaken with alumina powder instead of passing through column. The same problems were observed as described in point 4.
6. Filtration using syringe pumps: due to their sticky nature, polymer molecules stuck to the filter paper of the commercial 0.2 and 0.45 μm syringe filters.
7. Acetone and Isopropanol: acetone and isopropanol were used to precipitate the polymer from solution while keeping reagent in solutions. Different volume fractions of each solvent were tested. The polymers precipitated as big and compact flocks, which were impossible to re-dissolve and obtain single molecules.

All the above-mentioned trails failed in purifying the activated polymer or dye-labelled polymers. Therefore, a new approach was applied to modify the physical properties of the polymers. This was achieved by using an approximate 5 million-fold excess to polymer concentration is applied to trigger the transient chain bundling. This transient chain bundling causes a dramatic transient loss of the viscosity of the solution and promotes the formation of easily-washable polymer pellets. This drastic change in the physical properties of the polymer-EDC/NHS-fluorescent probe solution allows facile precipitation, washing and purification of the polymer molecules. Consequently, the excess reagents and dyes were efficiently removed by simple centrifugation, rather than membrane filtration used conventionally.

Additionally, the chain bundling state of the dye-labelled polymers was successfully reversed and the dye-labelled polymers regained the viscosifying property that is about the same as the polymer prior to labelling. The polymer solution's viscosity is attributed to single-molecule being dispersed into water and creating hydrogen bonds with water molecules; if polymer chains transiently bundle, they cannot achieve viscosifying properties. To reverse the chain bundling of polymers, the following methods were tested:
1. Sonication: sonication is a known method to promote disaggregation. Multiple trials were performed using different combinations of operating conditions including power, frequency and time. The unsuccessful results were either due to cutting polymer chains either not being able to completely break the polymer flakes (aggregates). One combination of operating conditions disintegrated most of the flakes and did not cut the polymers. However, this combination was not reproducible as the flake formation is random and their dimensions differ. Thus, sonication is not a method with reproducible results.
2. Surfactant: SDS surfactant was used to break the flakes. Different concentrations of SDS solution were tested with unsuccessful results.
3. Surfactant+sonication: surfactant was added to the dye-labelled polymer and the suspension was sonicated to re-disperse the flakes as single molecules. The results were rather unsuccessful as they could not be replicated. Each solution was different and trails for optimum combinations were needed every time (extremely time and labour-expensive).

The above methods (1-3) were not able to break all the flakes. Not all the flakes were dispersed as single molecules and the polymer solution did not regain viscosity.

Therefore, a “drying and soaking” technique was applied, which was successful. In order to reverse the chain bundling of the dye-labelled polymer and obtain a viscous polymer solution, the labelled-polymer was dried in high-vacuum oven for overnight at 40° C. and −30 kPa (the time period, temperature, and pressure can be adjusted based on the properties of the specific polymer—40° C. was used here to avoid thermal degradation of the polymers since these polymers tested in the Examples are temperature sensitive). Finally, the dried polymer was soaked in water and allowed for slow hydration such that the dye-labelled polymer molecules can disperse and the polymer solution gains viscosity. Heating the solution to 60° C. for overnight can speed up the dissolution process and restoring the polymer chain in its native condition (reverse the chain bundling).

The fluorescently labelled partially hydrolyzed polyacrylamide of 20 MD was confirmed using four different techniques: (1) atomic force microscopy (AFM), (2) Fourier-transform infrared spectroscopy (FTIR), (3) ultraviolet-visible spectroscopy (UV-Vis), and (4) single-molecule fluorescence microscopy. The measurement results are briefly described below.

### (1) Atomic Force Microscopy (AFM)

The atomic force microscopy experiments were performed both for the original HPAM polymer solution and the HPAM/EDC/NHS complex, which is the activated polymers.

Both experiments were performed in dry conditions, following identical sample preparation: a drop of each solution was poured on a mica surface and left to dry under vacuum conditions, in a desiccator.

The AFM caption of the HPAM illustrates a HPAM polymer molecule in its original state in solution (FIG. 4A). The HPAM polymer molecule is characterized by a circular shape and features such as artifact due to drying. In contrast, the AFM of the HPAM/EDC/NHS complex (FIG. 4B), i.e. the activated polymers, was captured 5 minutes after adding EDC/NHS. The reaction induces transient polymer chain bundling. The elongated features represent multiple polymer molecules chains bundled together forming pellets as macroscopic feather.

### 2) Fourier-Transform Infrared Spectroscopy (FTIR)

FTIR measurements were performed to identify the functional groups of interest in the HPAM polymers, the dye, and the labelled polymer, in order to verify the tagging of the molecules. The chemistry of the proposed labelling method is based on the EDC/NHS crosslinking of carboxylates with primary amines. Therefore, the formation of amide bonds on the labeled polymers confirms the successful labeling of the polymer.

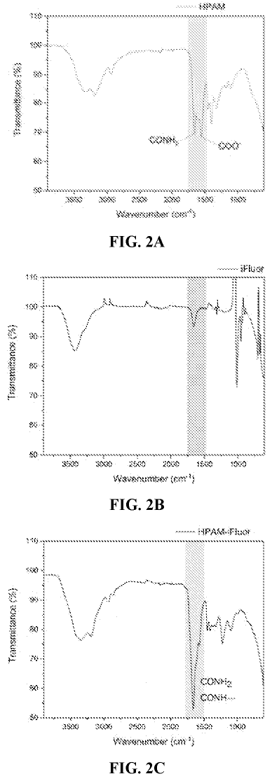

The initial HPAM polymers were in powder form while the dye and the labeled HPAM polymers were in solution. For the transmission measurement, a sample was placed directly into the infrared (IR) beam of the FTIR instrument. As the IR beam passes through the sample, the transmitted energy is measured, and a spectrum is generated. The spectra are shown in FIG. 2C.

In the carbodiimide chemistry, the primary amine of the dye, forms an amide bond with the carboxyl group of the HPAM. FIG. 2A shows the FTIR spectrum of the HPAM polymer, showing both the stretching bands (strong absorption) of the amides and the carboxyl functional groups. FIG. 2B shows the FTIR spectrum of the dye molecule, iFluor™ 647 amine, showing the bending (weak absorption) of the amine group of the iFluor™, 647 amine. FIG. 2C shows the FTIR spectrum of the dye-labeled HPAM polymer. The change of the doublet peak (HPAM) into singlet (HPAM-iFluor™) demonstrates the conversion of COOH to CONH— group linked to iFluor™. This demonstrates the formation of new amide bonds and therefore, confirms the labeling of the HPAM polymers.

### 3) Ultraviolet-Visible Spectroscopy (UV-Vis)

Ultraviolet-visible spectroscopy measurements were performed on the HPAM polymers, the fluorescent dye, and the dye-labelled HPAM polymer to characterize the materials and to confirm the labelling of the polymers.

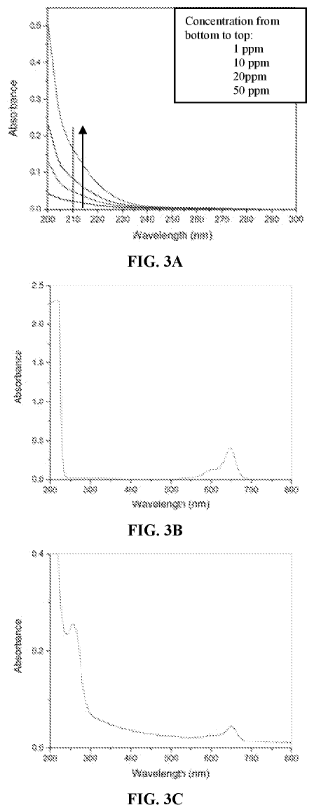

The UV-Vis measurements for the HPAM polymer were performed at different concentrations of the HPAM polymer. The HPAM polymer shows absorbance between 240 nm and 200 nm, characteristic to its chemical structure (FIG. 3A). The fluorescent dye exhibits the characteristic absorbance maxima at a wavelength around 660 nm (FIG. 3B). Furthermore, the measurements of the dye-labelled HPAM polymer, FIG. 3C, shows an absorbance peak at around 250 nm and an absorbance peak at around 660 nm, which demonstrates the successful labelling of the polymers.

### 4) Single-Molecule Fluorescence Microscopy

Single-molecule fluorescence microscopy attains information on individual molecules dynamics and motion pathways. As the technique relies on signals emitted by single molecules, it is imperative for the investigated molecules to be conjugated with reporters such as fluorescent dyes. The HPAM polymers do not exhibit fluorescent properties. Upon labelling with a fluorescent dye, the labelled HPAM polymer is able to be visualized using a single-molecule fluorescence microscopy setup.

Single-molecule fluorescence imaging of the dye-labelled polymer was conducted using a dye-labelled polymer solution on a custom-built epifluorescence microscopy setup. The setup includes an inverted microscope illuminated with a CW 60 mW 640-nm laser. The images of the dye-labelled HPAM polymer obtained using the single-molecule fluorescence microscopy shows in white the fluorescently labelled HPAM molecules (data not shown), demonstrating successful labelling of the polymer.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize or be able to ascertain using no more than routine experimentation, many equivalents to the specific forms of the invention described herein. Such equivalents are intended to be encompassed by the following claims.

1. A method for labeling a polymer with a dye,
wherein the polymer comprises a plurality of subunits, wherein at least one subunit comprises a carboxyl group or a functional group that is convertible to a carboxyl group, optionally more than one carboxyl group or more than one functional group that is convertible to a carboxyl group,
wherein the dye comprises an amino group, optionally more than one amino group,
wherein the method comprises
(i) mixing the polymer with an activation agent, optionally a mixture of two or more activation agents, in a first buffer solution,
wherein upon activation, the polymer bundles in the first buffer solution and forms an activated polymer in the first buffer solution; and
(ii) mixing the activated polymer with the dye in a second buffer solution to form a dye-labeled polymer in the second buffer solution.

2. The method of claim 1, wherein the activated polymer is suspended in the first buffer solution and/or the second buffer solution, and optionally the dye-labeled polymer is suspended in the second buffer solution.

3. The method of claim 1, wherein the polymer is a partially hydrolyzed polyacrylamide, an anionic polyacrylamide, an associative polymer, polycarboxylate ether, polyaspartic acids, polyglutamic acids, or polymaleic acids, or copolymers thereof.

4. The method of claim 1, wherein the polymer has a weight average molecular weight (Mw) of >5 MDa, >6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa.

5. The method of claim 1, wherein: (a) the dye comprises a primary amino group, optionally more than one primary amino group; and/or (b) the activation agent is 1-ethyl-3-(3-dimethylaminopropyl)carbodiimide (EDC), optionally a mixture of EDC and N-hydroxysuccinimide (NHS).

6. (canceled)

7. The method of claim 65, wherein the concentration (mole/L) of EDC is at least 4×10⁵, at least 10⁶, at least 1.5×10⁶, at least 2×10⁶, at least 2.5×10⁶, at least 3×10⁶, at least 3.5×10⁶, at least 4×10⁶, at least 4.5×10⁶, or at least 5×10⁶ fold of the concentration of the polymer and the concentration (mole/L) of NHS is about half of the concentration of EDC.

8. The method of claim 1, wherein: (a) the first buffer solution has a pH in a range from about 5 to about 5.5; (b) the second buffer has a pH in a range from about 7 to about 8; and/or (c) the polymer in step (i) is in the form of a solution.

9. (canceled)

10. (canceled)

11. The method of claim 1 further comprising (iii) purifying the activated polymer after step (i) and prior to step (ii), wherein step (iii) comprises
(iii-a) centrifuging the first buffer solution containing the activated polymer to produce a first precipitate and a first supernatant, wherein the first precipitate comprises the activated polymer,
(iii-b) decanting the first supernatant to separate the first precipitate and the first supernatant.

12. The method of claim 1 further comprising (iv) purifying the dye-labeled polymer after step (ii), wherein step (iv) comprises
(iv-a) centrifuging the second buffer solution containing the dye-labeled polymer to produce a second precipitate and a second supernatant, wherein the second precipitate comprises the dye-labeled polymer,
(iv-b) decanting the second supernatant to separate the second precipitate and the second supernatant, and optionally,
(iv-c) drying the second precipitate to provide the dye-labeled polymer.

13. The method of claim 1 further comprising (v) washing the second precipitate comprising the dye-labeled polymer, optionally the dye-labeled polymer, with a washing solvent, wherein step (v) comprises
(v-a) mixing the washing solvent with the second precipitate, optionally the dye-labeled polymer, optionally, the dye-labeled polymer is suspended in the washing solvent,
(v-b) centrifuging the washing solvent containing the dye-labeled polymer to produce a product precipitate and a waste supernatant, wherein the product precipitate comprises the dye-labeled polymer, and
(v-c) decanting the waste supernatant to separate the product precipitate and the waste supernatant.

14. The method of claim 13, wherein steps (v-a)-(v-c) are repeated with the product precipitate for at least one time or at least two times.

15. The method of claim 1 further comprising (vi) drying the product precipitate to provide the dye-labeled polymer.

16. The method of claim 1, wherein the dye-labeled polymer precipitate is combined with water and sonicated for 5 s, and up to 1-2 mins, wherein sonication alone is effective to disperse the dye-labeled polymer in the water.

17. The method of claim 15 wherein the dye-labeled polymer is dried in a high-vacuum oven at a temperature between 25° C. and 40° C., under a pressure in a range from −15 kPa to −30 kPa, for a time period from 8 hours to 48 hours, the method optionally further comprising soaking the dye-labeled polymer in water at a temperature from 25° C. to 65° C. for a time period from 8 hours to 72 hours to dissolve the dye-labeled polymer in water.

18. The method of claim 1, wherein the dye-labeled polymer has the same or substantially the same viscosity as the polymer prior to labeling.

19. A dye-labeled polymer formed from a polymer and a dye,
wherein the polymer has a Mw of >5 megadalton (MDa), >6 MDa, ≥8 MDa, ≥10 MDa, ≥12 MDa, ≥15 MDa, ≥20 MDa, up to 100 MDa, between 5 MDa and 20 MDa, or between 6 MDa and 20 MDa,
wherein the dye-labeled polymer comprises at least one subunit having the structure of formula 1 in the brackets: 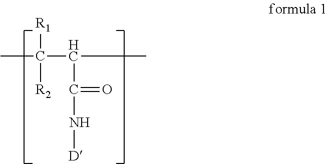
wherein R₁ and R₂ are independently hydrogen, substituted or non-substituted alkyl group, substituted or non-substituted alkenyl group, substituted or non-substituted aryl group, substituted or non-substituted alkyl-aryl group,
wherein NH-D′ is the dye which is linked to the subunit having the structure of formula 1, and optionally
wherein the dye-labeled polymer is formed by the method of claim 1.

20. An activated polymer formed from a polymer and an activation agent, optionally a mixture of two or more activation agents,
wherein the polymer comprises a plurality of subunits, wherein at least one subunit comprises a carboxyl group, optionally more than one carboxyl groups,
wherein the activated polymer is formed by mixing the polymer with the activation agent, optionally the mixture of two or more activation agents, in a first buffer solution, and
wherein upon activation, the polymer bundles in the first buffer solution and forms the activated polymer in the first buffer solution.

21. The activated polymer of claim 20, wherein; (a) the activated polymer is suspended in the first buffer solution; (b) the polymer has a Mw of >5 megadalton (MDa), >6 MDa, ≥8 MDa, ≥10 MDa, ≥12 MDa, ≥15 MDa, 20 MDa, up to 100 MDa, between 5 MDa and 20 MDa, or between 6 MDa and 20 MDa; and/or (c) the activation agent is EDC, optionally is a mixture of EDC and NHS.

22. (canceled)

23. The activated polymer of claim 21, wherein the activation agent is a mixture of EDC and NHS and wherein the concentration (mole/L) of EDC is at least 4×10⁵, at least 10⁶, at least 1.5×10⁶, at least 2×10⁶, at least 2.5×10⁶, at least 3×10⁶, at least 3.5×10⁶, at least 4×10⁶, at least 4.5×10⁶, or at least 5×10⁶ fold of the concentration of the polymer and the concentration (mole/L) of NHS is about half of the concentration of EDC.

24. (canceled)

25. The dye-labeled polymer of claim 19, wherein the polymer is a partially hydrolyzed polyacrylamide, an anionic polyacrylamide, an associative polymer, polycarboxylate ether, polyaspartic acids, polyglutamic acids, or polymaleic acids, or copolymers thereof.
